(19) United States
(12) Patent Application Publication
(10) Pub. No.: US 2001/0037417 A1
(43) Pub. Date: Nov. 1, 2001

(54) Method and system for dynamically dispatching function calls from a first execution environment to a second execution environment

(76) Inventor: Markus Meyer, Winsen/Luhe (DE)

Correspondence Address: Forrest Gunnison, Gunnison, McKay & Hodgson, L.L.P., Suite 220, 1900 Garden Road, Monterey, CA, 93940, US

(21) Appl. No.: 09/760,321

(22) Filed: Jan. 12, 2001

(30) Foreign Application Priority Data
Jan. 14, 2000 (EP) 00100212.0

(51) Int. Cl. G06F 9/44; G06F 9/00

(52) U.S. Cl. 709/332; 709/315

(57) ABSTRACT

A method for enabling a first software program using a first binary specification in a first execution environment to employ a limited functionality of a second software program using a second binary specification in a second execution environment first creates a bridge in the first execution environment. Using the bridge, a proxy wrapping an interface to the limited functionality of the second software program in the second execution environment is created in the first execution environment. The proxy is used to access the limited functionality of the second software program in the second execution environment.

### BACKGROUND OF THE INVENTION

1. Field of the Invention

The present invention relates generally to executing computer software programs generated by different compilers, and in particular to a method for enabling a first computer software program using a first binary specification to employ functionality of a second computer software program using a second binary specification.

2. Description of Related Art

Many computer software programs, which are created in different programming languages, have to communicate with each other. For example, a first computer software program, sometimes called the first software program, created in a first computer programming language is able to provide tables. The first software program calls a second software program created in a second programming language, which is able to calculate figures that are needed in the table to be produced by the first software program. (As those of skill in the art will appreciate, when it is stated that a software program performs an action, this means that upon execution of the software program on a processor, the system including the processor performs the action in response to execution of an instruction or instructions in the software program.)

Since the two software programs are written in different languages, the two software programs have different binary specifications. The second software program cannot be successfully called by the first software program because the different binary specifications prevents the second software program from correctly executing the call from the first software program.

In this example, the different binary specifications result from different computer programming languages. However, binary specifications for the same computer programming language can be different based upon the differences in the compilers for the same programming language.

The prior art solution to this problem was to provide transformer modules for each required transformation route, for example from a certain first binary specification to a certain second binary specification. Since in modern computer applications, a certain software program may call many different software programs, the computer system requires a voluminous library of transformer modules. This extensive library needs significant storage space and regular maintenance, since for every new binary specification, which shall be accessible, a full new set of transformer modules must be provided to each of the other binary specifications, in addition to the existing transformer modules. However, most of these transformer modules are not used frequently, so that their storage is not efficient.

Furthermore, these prior art transformer modules extend to the full functionality of the software program to be translated from one binary specification to another. Due to the regularly wide functionality of software programs, known transformer modules are rather voluminous and require, when they are activated, a significant amount of working memory and processor time from the computer system on which they are executed. Furthermore, the complete translation of a software program is burdensome and time consuming, although it is in most cases unnecessary for the specific task to be accomplished.

### SUMMARY OF THE INVENTION

According to one embodiment of the present invention, an efficient method is provided to enable a first software program to employ certain functionalities of a second software program, where the first and the second software program use different binary specifications, i.e., the first and second software programs are in different execution environments.

In one embodiment, a method for enabling a first software program using a first binary specification in a first execution environment to employ a limited functionality of a second software program using a second binary specification in a second execution environment first creates a bridge in the first execution environment. Using the bridge, a proxy wrapping an interface to the limited functionality of the second software program in the second execution environment is created in the first execution environment.

In another embodiment, a method, dynamically implemented by a process in a first execution environment generates a binary specification object for the first execution environment. A binary specification object for a second execution environment is also generated. Next the process generates a bridge object for mapping objects from the second execution environment to the first execution environment. For example, using the bridge object, the process generates a proxy wrapping an interface in the second execution environment. The interface in the second execution environment is used to access limited functionality in the second execution environment.

In one embodiment, to use the limited functionality in the second execution environment in a first execution environment, a process executing in the first execution environment calls a method in a proxy interface in the first execution environment. In response to the call, the proxy interface converts the method to a corresponding method call for execution in the second execution environment. A method type description is used to convert parameters from the first execution environment to the second execution environment, and in one embodiment, a parameter type description for the method is used.

The proxy interface dispatches the corresponding method call for execution in the second execution environment to the second execution environment by the proxy interface. In response to the corresponding method call in the second execution environment, the method providing the limited functionality is executed and the results of the execution are returned to the proxy interface. Using a type description, the returned results from the second execution environment are converted to the first execution environment and returned to the calling process. In one embodiment, the second execution environment is a C++ programming language execution environment.

In another embodiment of this invention, a computer program product comprises computer program code for a method for enabling a first software program using a first binary specification in a first execution environment to employ a limited functionality of a second software program using a second binary specification in a second execution environment, the method comprising:

creating a bridge in said first execution environment; and

creating, in said first execution environment using said bridge, a proxy wrapping an interface to said limited functionality of said second software program in said second execution environment.

In another embodiment, a computer program product comprises computer program code for a method for using functionality in a second execution environment in a first execution environment, the method comprising:

calling a method in a proxy interface in said first execution environment; and

converting said method call by said proxy interface to a corresponding method call for execution in said second execution environment.

One embodiment of the present invention includes a computer storage medium having stored therein a structure comprising a binary specification for an execution environment that in turn includes a simple common identity structure. Optionally, the binary specification also includes an extended environment structure. In one embodiment, the simple common identity structure includes: a type name, a context, a pointer to the extended environment structure, and methods acquire, release and dispose.

### BRIEF DESCRIPTION OF THE DRAWINGS

FIG. 1A is a high level representation of a first embodiment of the present invention.

FIG. 1B is a high level representation of a second embodiment of the present invention.

FIG. 1C is a more detailed representation of the first embodiment of the present invention.

FIGS. 2A and 2B are one embodiment of a binary representation of an environment according to one embodiment of the present invention.

FIGS. 3A and 3B are one embodiment of the binary specification structure of FIG. 2B.

FIG. 4 is a sequence diagram illustrating one embodiment of making a proxy interface of the present invention, and one embodiment of using the proxy interface of the present invention.

FIG. 5 is an example of a binary specification of the type representation in the UNO typelibrary according to one embodiment of the present invention.

FIG. 6 is an illustration of stack configuration used in one embodiment of a C++ environment.

FIG. 7A is an illustration of a virtual table in one embodiment of the present invention.

FIG. 7B is an illustration of assembler code used to generate an index to a slot in the virtual table of FIG. 6.

FIG. 8 is a process flow diagram for one embodiment of a method performed by a C++ proxy wrapping a UNO interface.

FIG. 9 is a process flow diagram for one embodiment of a method mediate that is used by the method of FIG. 8.

FIG. 10 is a process flow diagram for one embodiment of a method Env1_to_Env2 with interface that is used by method mediate of FIG. 9.

FIG. 11 is a process flow diagram for one embodiment of a method performed by a UNO proxy wrapping a C++ interface.

FIG. 12 is a process flow diagram for one embodiment of a method Env2_to_Env1 with interface that used by the method of FIG. 11.

FIGS. 13A and 13B are an example of mapping an interface from a UNO environment to a C++ UNO environment according to one embodiment of the present invention.

FIG. 14 is an example of freeing a C++ UNO interface proxy and revoking the proxy of the appropriate environment according to one embodiment of the present invention.

FIG. 15 is an example of a C++ implementation of a C++ UNO proxy according to one embodiment of the present invention.

FIGS. 16A and 16B are an example of a C implementation of freeing a UNO interface proxy and functions acquire/release according to one embodiment of the present invention.

FIGS. 17A and 17B are an example of mapping an interface from a C++ UNO environment to a UNO environment according to one embodiment of the present invention.

FIG. 18 is an example of a C++ implementation of a UNO proxy according to one embodiment of the present invention.

FIG. 19 is an example of various constructors of a mapping and a bridge and of a free function of a bridge according to one embodiment of the present invention.

FIG. 20 is an example of an implementation of functions acquire and release for a bridge according to one embodiment of the present invention.

FIG. 21 is an example of an implementation to create a mapping between to environments according to one embodiment of the present invention.

FIGS. 22A and 22B are an example of an implementation to create the static part of an object identifier according to one embodiment of the present invention.

FIG. 23 is an example of an implementation to create an object identifier according to one embodiment of the present invention.

FIG. 24 is an example of an implementation of methods acquire/release in a C++ UNO environment according to one embodiment of the present invention.

In the Figures and the following Detailed Description, elements with the same reference numeral are the same element or a similar element. Also, the first digit of a reference numeral for an element indicates the figure in which that element first appeared.

### DETAILED DESCRIPTION

According to one embodiment of the present invention, a computing system 100 includes a service 111, which is part of a first computer software program 110 executing within a first execution environment 120. Service 111 issues a call 112 to a service 161 of a second computer software program 160 executing within a second execution environment 150 that is different from first execution environment 120. For example, service 111, in one embodiment, is a part of a word processing program that issues a call to a calculator, which is service 161, of a spreadsheet program, where the word processing program is written in a Visual Basic computer programming language, and the calculator is written in the C programming language.

Unlike the prior art in which calls to a different execution environment with a different binary specification could not be handled in most cases, and in a limited number of cases could be handled by marshalling the call into a specific predefined byte stream (for example the CORBA byte stream) for passing to the different execution environment, call 112 from first execution environment 120 with a first binary specification is directed to a proxy 130 in a bridge 140. Proxy 130 converts any parameters in the call to parameters for second execution environment 150 using a type description that is described more completely below, and then dispatches a call 170, with the converted parameters, to service 161 in second execution environment 150. Call 170 corresponds to call 112 in first execution environment 120.

In response to call 170 from proxy 130, service 161 performs the action requested and returns the result to proxy 130. Proxy 130 converts the result and any parameters returned from second execution environment 150 to first execution environment 120. The converted results are in turn provided to service 111.

Hence, according to one embodiment of the present invention, a first service, sometimes called a component or an object, with a first binary specification in a first execution environment utilizes a second service sometimes called a component or an object, in a second execution environment with a second binary specification that is different from the first binary specification. This greatly extends and facilitates providing an application with a broad range of capabilities without having to port the application and/or all of the capabilities to the binary specification of each execution environment in which the application may run. In addition, this embodiment facilitates providing a particular functionality to an application that is executed in an execution environment that does not, and perhaps cannot, support that particular functionality.

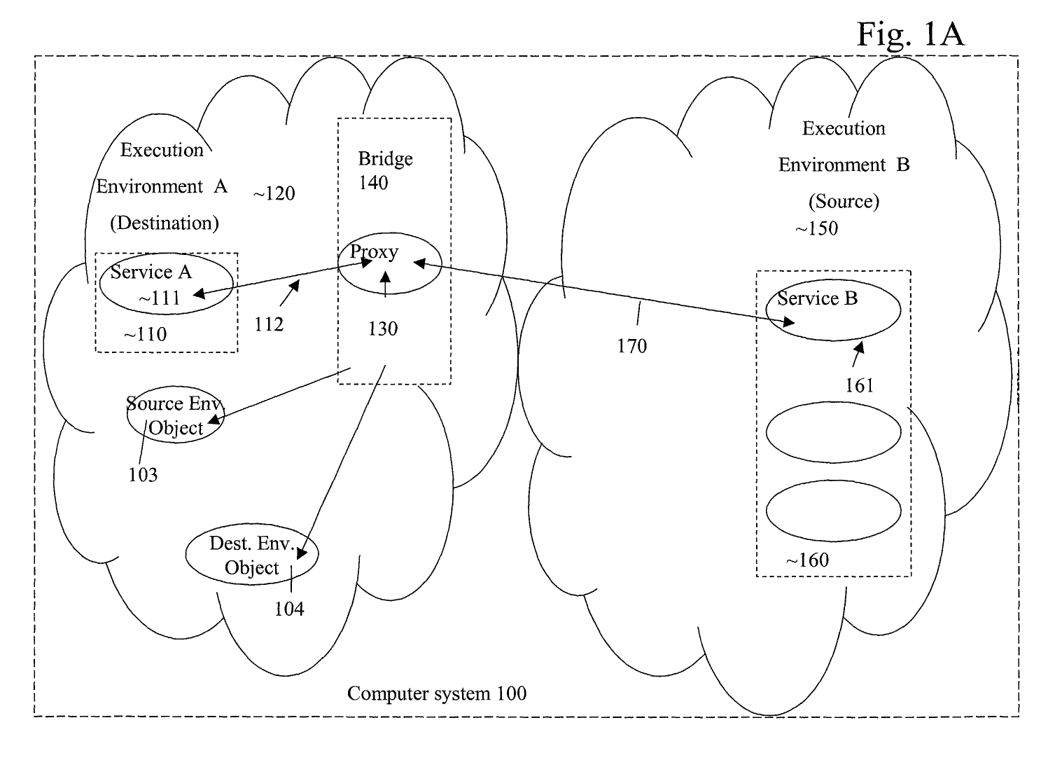

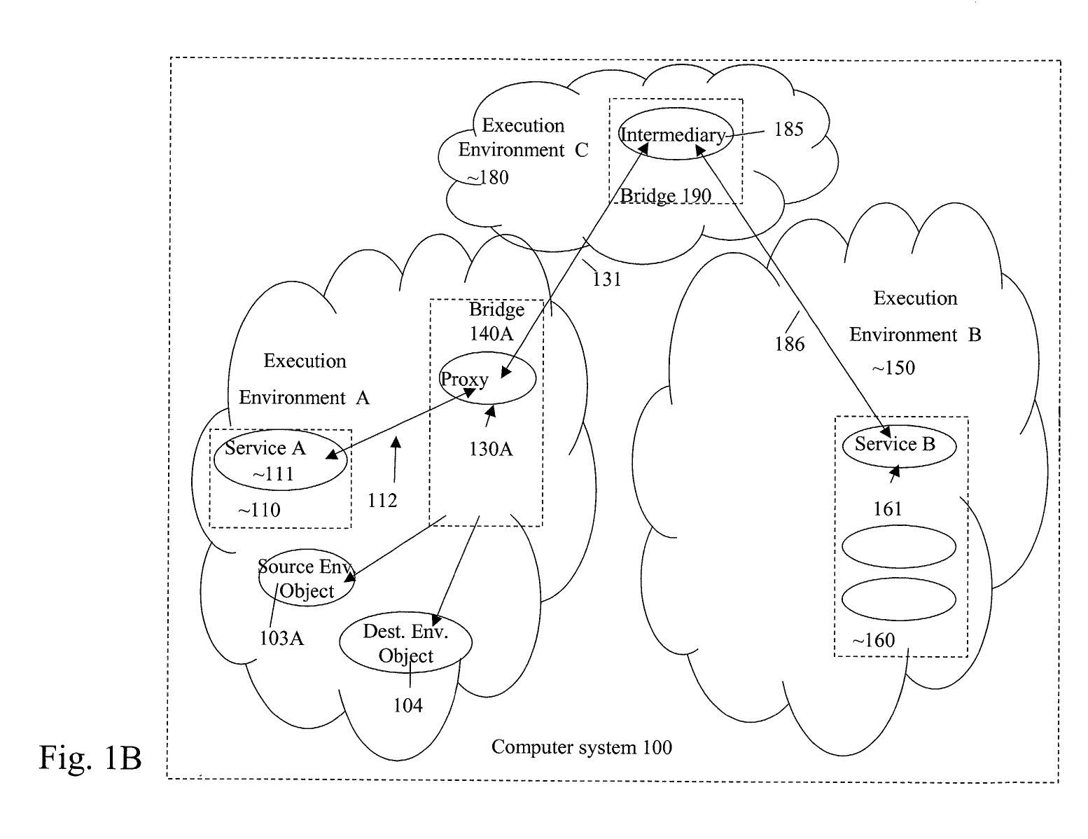

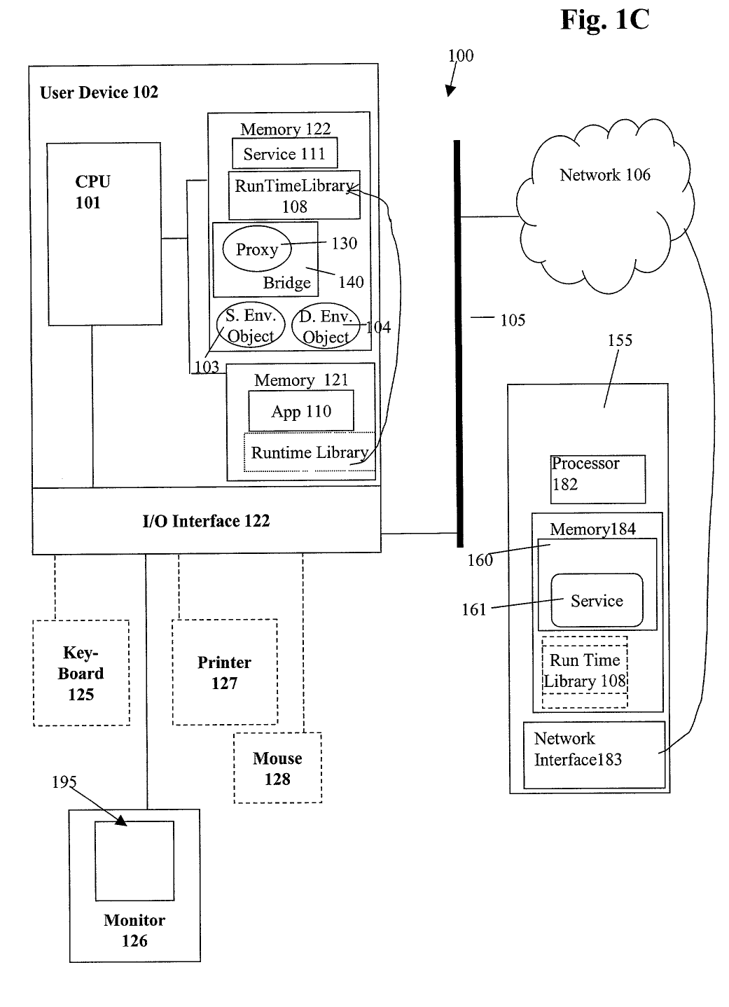

In the embodiment of FIG. 1A, proxy 130 is instantiated by bridge 140 that is in first execution environment 120 and proxy 130 communicates directly with service 161 that is in second execution environment 150. However, in another embodiment, proxy 130A in response to a call 112 from service 111 of software program 110 issues a call 131 to an intermediary proxy 185 in execution environment 180 that is different from both execution environment 120 and execution environment 150, in this example.

Intermediary proxy 130A converts the call from the first binary specification to the binary specification for execution environment 180 and dispatches a call 131 to intermediary proxy 185. Intermediary proxy 185 converts the call from the binary specification of execution environment 180 to the binary specification of execution environment 150 and then dispatches call 186 to service 161. The response from service 161 is returned to intermediary proxy 185 that converts the response to binary specification of execution environment 180, and in turn transmits the converted response to proxy 130A. Proxy 130A converts the response from the binary specification for execution environment 180 to the binary specification for execution environment 120 and returns the result to service 111 of software program 110.

To reduce the number of bridges, normally only bridges to intermediate environment 180, referred to herein as the binary UNO specification environment, exist. To make a bridge from a C programming language (C) execution environment to a C++ programming language (C++) execution environment, call traffic is delegated over two bridges 140A and 190. First bridge 140A is from the C execution environment to the binary UNO execution environment and then bridge 190 is from the binary UNO execution environment to the C++ execution environment. In this way, only (n−1) bridges are needed for n different environments instead of n*(n−1)/2 bridges, if a direct connection between environments is made as in FIG. 1A. Preferably each bridge can create proxy objects only from the description of an interface. This implies that the code may be generated at runtime.

Returning to FIG. 1A, as explained more completely below, a source environment object 103 and a destination environment object 104 are initially created using a runtime library, and optionally registered in an execution environment, e.g., execution environment 120. Each of objects 103 and 104 includes a binary specification structure for its respective execution environment. As explained more completely below, a binary specification structure, in one embodiment, provides common functions for each environment, and knows all proxies, sometimes called proxy interfaces, and their origins. Thus, an execution environment, through its binary specification structure, knows each wrapped interface, i.e., proxy, running in execution environment and the origin of each of these wrapped interfaces.

After the objects 103 and 104 are created, a call is made by service 111 that results in a search for a shared library that is activated as a bridge for the two execution environments. Each bridge, e.g., bridge 140, is implemented in a separate shared library. In one embodiment, the name of the shared library is a connection of two environment names with an underscore (‘_’) between the names.

Next a call is made by service 111 to map an interface of the source environment. Mapping is the direct way to publish an interface in another environment. That means an interface is mapped from a source environment 150 to a destination environment 120 so that methods may be invoked on a mapped interface, i.e., proxy 130, in destination environment 120, which, in turn, are delegated to the originating interface in the source environment.

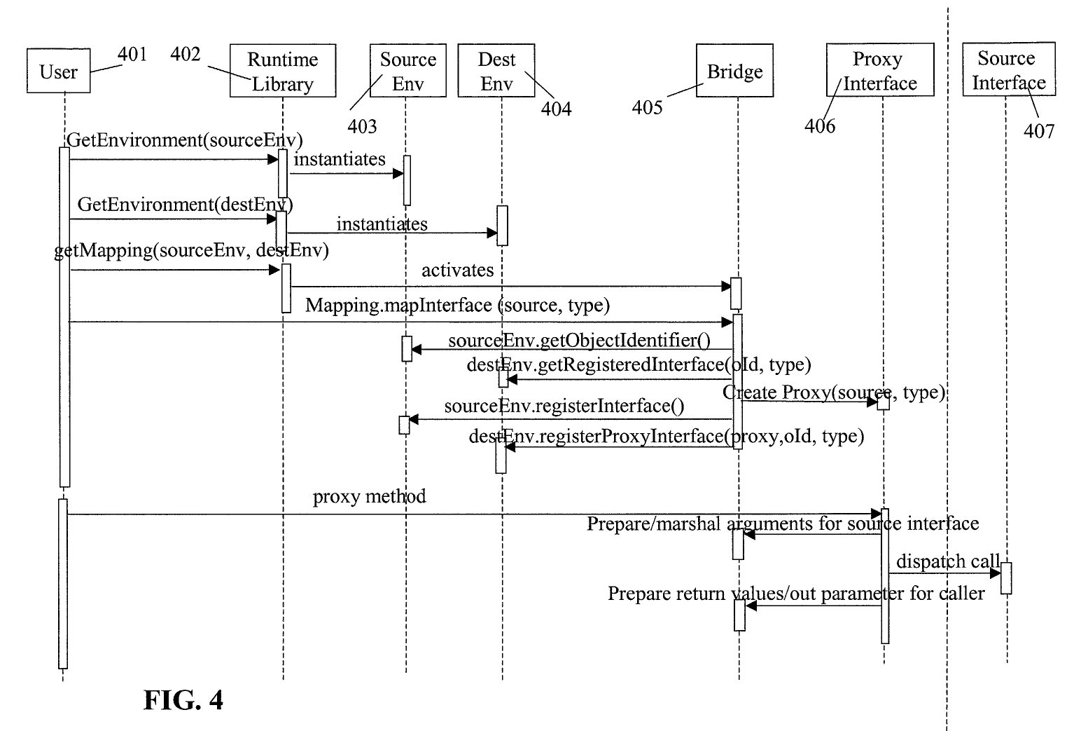

Mapping an interface from an environment 150 to an environment 120 requires several operations that are described more completely below with respect to FIG. 4. However, briefly, a call is made to bridge 140 to map a particular interface for service 161 in source execution environment 150 to destination execution environment 120. If a proxy already exists for this mapping, a handle to the proxy is returned to service 111. Alternatively, as explained below, bridge 140 creates proxy 130, and returns a handle to service 111 so that subsequent calls to the interface for service 161 are directed to proxy 130.

Hence, as used herein, a bridge 140 in a first environment 120 is defined to be a software module that upon execution initially creates a proxy object 130 in first environment 120 for one computer programming language and hardware platform so that an actual object 161, sometimes called real object 161, represented by proxy 130, is available from a second environment 150. Proxy object 130 looks like and is an object implemented in first environment 120, and so proxy object 130 can be transparently used. Proxy object 130 delegates calls to real object 161 in second environment 150.

In one embodiment, real object 161 in second environment 150 is implemented in the C programming language (C) and real object 161 is accessed from a C++ programming language (C++) environment. In this case, bridge 140 is from a C++ environment to a C environment. Remember that C++ is incompatible between different compilers and different switches. Bridge 140 creates a C++ proxy object 130 in first environment 120, which delegates calls to real object 161 implemented in C. Sometimes a bridge is called language binding, but this description is not exact, because bridges also connect object models in another embodiment of the present invention.

The particular configuration of computing system 100 is not essential to this invention. Execution environments 120 and 150, in one embodiment, are included within the same computer.

In another embodiment, execution environment 120 is in a client system and execution environment 150 is in a server system. In this embodiment, the client system can be a mobile telephone, a two-way pager, a portable computer, a workstation, or perhaps a personal computer. The client and server can be interconnected by a local area network, a wide area network, or the Internet. As explained more completely below, the dynamic dispatch functionality of this invention is independent of the network protocol and the network architecture. In yet another embodiment, execution environment 120 is in a first computer and execution environment 150 is in a second computer where the first and second computers are in a peer-to-peer network.

FIG. 1C is an example of a user device 102 that is executing service 111 of application 110 from a volatile memory 122 on CPU 101. Application 110 can be any application, or an application in a suite of applications that can include for example a word processing application, a spreadsheet application, a database application, a graphics and drawing application, an e-mail application, a contacts manager application, a schedule application, and a presentation application. One office application package suitable for use with this embodiment of the invention, is the STAROFFICE Application Suite available from Sun Microsystems, 901 San Antonio Road, Palo Alto, Calif. (STAROFFICE is a trademark of Sun Microsystems, Inc.) The user has access to the functionality of service 161 even thought the execution environment for computer 155 is different from the execution environment of user device 102 and even in situations where in addition user device 102 has neither the memory capacity nor the processing power to execute service 161.

In the embodiment of FIG. 1C, a runtime library 108 is initially stored in a non-volatile memory 121 and a part or all of runtime library 108 is moved to volatile memory 122 to generate source environment object 103, destination environment object 104 and bridge 140. In one embodiment, bridge 140 includes a shared library and is the same library as runtime library 108.

In this embodiment, when proxy 130 receives a method call from service 111, proxy 130 dispatches the call to service 161 via I/O interface 122 that is connected to network interface 183 of computer 155 via networks 105 and 106.

Those skilled in the art will readily understand that the operations and actions described herein represent actions performed by a CPU of a computer in accordance with computer instructions provided by a computer program. Therefore, bridge 140, proxy 130, source environment object 103, and destination environment object 104 may be implemented by a computer program causing the CPU of the computer to carry out instructions representing the individual operations or actions as described herein. The computer instructions can also be stored on a computer-readable medium, or they can be embodied in any computer-readable medium such as any communications link, like a transmission link to a LAN, a link to the internet, or the like.

Thus, all or part of the present invention can be implemented by a computer program comprising computer program code or application code. This application code or computer program code may be embodied in any form of a computer program product. A computer program product comprises a medium configured to store or transport this computer-readable code, or in which this computer-readable code may be embedded. Some examples of computer program products are CD-ROM discs, ROM cards, floppy discs, magnetic tapes, computer hard drives, servers on a network, and carrier waves. The computer program product may also comprise signals, which do not use carrier waves, such as digital signals transmitted over a network (including the Internet) without the use of a carrier wave.

The storage medium including runtime library 108 may belong to user device 102 itself. However, the storage medium also may be removed from user device 102. The only requirement is that the runtime library is accessible by user device 102 so that the computer code corresponding to the environment objects, bridge and proxy can be executed by user device 102. Moreover, runtime library 108 can be downloaded from another computer coupled to user device 102 via a network. Also, user device 102, as explained above, can also be a server computer and so the configuration of FIG. 1C is illustrative only and is not intended to limit the invention to the specific embodiment shown.

Herein, a computer memory refers to a volatile memory, a non-volatile memory, or a combination of the two in any one of these devices. Similarly, a computer input unit and a display unit refer to the features providing the required functionality to input the information described herein, and to display the information described herein, respectively, in any one of the aforementioned or equivalent devices.

As used herein, software programs are compiled executable programs. Software programs are initially written in a programming language, for example, C, C++ or JAVA or an object model like CORBA or UNO. They are compiled with compilers corresponding to the programming language. However, for each programming language several compilers may be available. The binary specification in which a software program is able to communicate with other software programs depends on both, the programming language and the compiler. This communication language of a software program is the language referred herein as the binary specification used by a software program.

As used herein, an execution environment, such as execution environments 120 and 150, contains all objects, which have the same binary specification and which lie in the same process address space. The execution environment, sometimes called environment, herein, is specific for a computer programming language and for a compiler for that computer programming language. For example, an object resides in the “msci” execution environment, if the object is implemented with a software program written in the C++ computer programming language, and the software program is compiled with the MICROSOFT Visual C++ compiler. (MICROSOFT is a trademark of Microsoft Corp. of Redmond, Wash.) An example of a binary specification for one sample execution environment is presented below in conjunction with the description of Table 1.

To assist in the understanding of this invention, examples of a binary specification for an environment, and types, type libraries, and a type repository are first considered, and then embodiments to make and use the present invention are described.

Binary Specification for an Execution Environment.

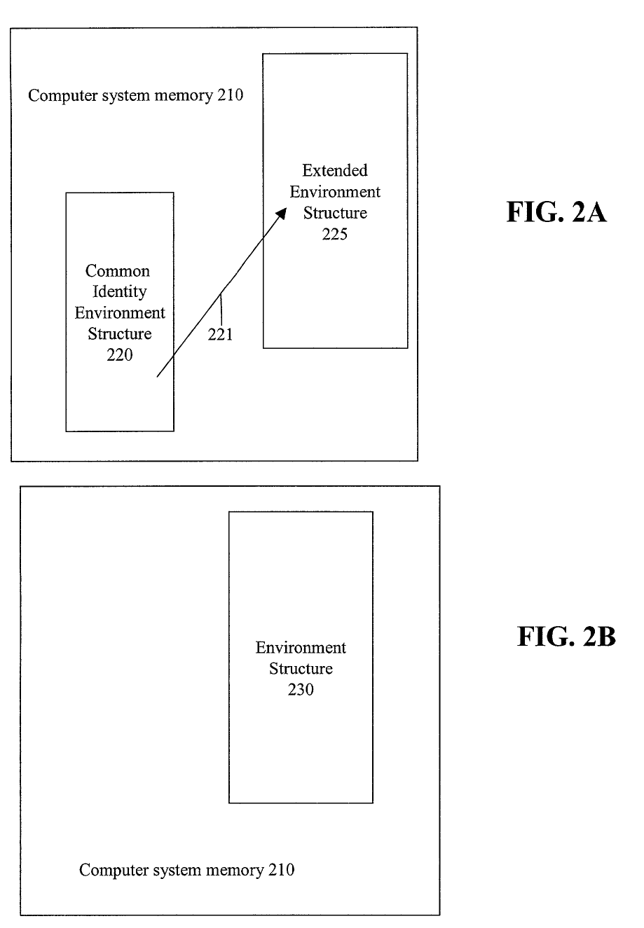

The function of a binary specification for an execution environment is to identify the execution environment, and optionally to provide functionality like interface registration. In one embodiment, the structure of a binary specification for an execution environment is split into a simple common identity structure 220 (See FIG. 2A) that is easily implemented for bridges that handle object identity issues. An optional structure 225 may be included to support optional functionality. In one embodiment, the optional functionality includes interface registration, acquiring/releasing in interfaces of the environment, and obtaining an object identifier for an interface.

Table 1 is an example of a simple common identity structure 220 (FIG. 2) of a binary specificaiton for an execution environment called uno_enviroment.

TABLE 1
One Embodiment of a Simple Common Identity
Structure for a Binary Specification of an Execution
Environment

typedef struct_uno_Environment
{

| | |
|---|---|
| void * | pReserved; |
| rtl_uString * | pTypeName; |
| void * | pContext; |
| uno_ExtEnvironment * | pExtEnv; |

| | |
|---|---|
| void (SAL_CALL * acquire) | ( uno_Environment * pEnv ); |
| void (SAL_CALL * release) | ( uno_Environment * pEnv ); |
| void (SAL_CALL * dispose) | ( uno_Environment * pEnv ); |

void (SAL_CALL * environmentDisposing) (

uno_Environment * pEnv );

} uno_Environment;

Pointer pReserved in the UNO environment is reserved and so in this embodiment is set to zero. String pTypeName is a type name of the environment. Pointer pContext is a free context pointer that is used for specific classes of environments, e.g., a JAVA virtual machine pointer. (JAVA is a trademark of Sun Microsystems, Inc. of Palo Alto, Calif.) Pointer pExtEnv is a pointer to and extended environment (interface registration functionality), if supported, and otherwise is set to zero.

Method acquire acquires this environment, i.e., the environment defined by this structure. Parameter pEnv is this environment. Method release releases this environment and again parameter pEnv is this environment. Method dispose is explicitly called to dispose of this environment, e.g., to release all interfaces. Typically, this method is called before shutting down to prevent a runtime error.

In this embodiment, method disposing is a disposing callback function pointer that can be set to be signaled before this environment is destroyed. This method is late initialized by a matching bridge and is not for public use.

Hence, in the embodiment, each simple common identity binary specification structure for an environment includes a type name of the environment; a free context pointer, a pointer to an extended environment that includes optional functionality, and methods to acquire, release and dispose of the environment. Structure 220 is stored in a memory 210 of computer system 100.

TABLE 2
One Embodiment of an Extended Environment
Structure for a Binary Specification of an Execution
Environment

typedef struct_uno_ExtEnvironment
{

uno_Environment aBase;
void (SAL_CALL * registerInterface) (

uno_ExtEnvironment * pEnv,
void ** ppInterface,
rtl_uString * pOId,
typelib_InterfaceTypeDescription * pTypeDescr );

void (SAL_CALL * registerProxyInterface) (

uno_ExtEnvironment * pEnv,
void ** ppProxy,
uno_freeProxyFunc freeProxy,
rtl_uString * pOId,
typelib_InterfaceTypeDescription * pTypeDescr );

void (SAL_CALL * revokeInterface) (

uno_ExtEnvironment * pEnv, void * pInterface );

void (SAL_CALL * getObjectIdentifier) (

uno_ExtEnvironment * pEnv,
rtl_uString ** ppOId,
void * pInterface );

void (SAL_CALL * getRegisteredInterface) (

uno_ExtEnvironment * pEnv,
void ** ppInterface,
rtl_uString * pOId,
typelib_InterfaceTypeDescription * pTypeDescr );

void (SAL_CALL * getRegisteredInterfaces) (

uno_ExtEnvironment * pEnv,
void *** pppInterfaces,
sal_Int32 * pnLen,
uno_memAlloc memAlloc );

void (SAL_CALL * computeObjectIdentifier) (

uno_ExtEnvironment * pEnv,
rtl_uString ** ppOId, void * pInterface );

void (SAL_CALL * acquireInterface) (

uno_ExtEnvironment * pEnv, void * pInterface );

void (SAL_CALL * releaseInterface) (

uno_ExtEnvironment * pEnv, void * pInterface );

} uno_ExtEnvironment;

Table 2 is one embodiment of a binary specification of an UNO environment supporting interface registration. This binary specification inherits all members of a uno_Environment as defined, for example, by Table 1 above.

Method registerInterface in Table 2 registers an interface of this environment. Parameter pEnv is this environment. Parameter ppInterface is an inout parameter of the interface to be registered. Parameter pOId is an object id of the interface to be registered, and parameter is a type description of interface to be registered.

Method registerProxyInterface in Table 2 registers a proxy interface of this environment. The proxy interface can be reanimated and is freed explicitly by this environment. In this call, parameter pEnv is this environment. Parameter ppInterface is an inout parameter of interface to be registered. Parameter freeproxy represents a function to free this proxy object (See Table 3). Parameter pOId is an object id of the interface to be registered, and parameter is a type description of interface to be registered.

Method revokeInterface revokes an interface from this environment. Any interface that has been registered must be revoked via this method. In the call to this method, parameter pEnv is this environment, and parameter pInterface is the interface to be revoked.

Method getObjectIdentifier provides the object id of a given interface. In this method, parameter ppOId is the input and output object identifier (oid), and parameter pInterface is the interface of the object.

Method getRegisteredInterface retrieves an interface identified by its object id and type from this environment. Interfaces are retrieved in the same order as they are registered. In this method, parameter pEnv is this environment. Parameter ppInterface is the inout parameter for the registered interface and is zero if none was found. Parameter pOId is the object id of the interface to be retrieved, and parameter pTypeDescr is a type description of interface to be retrieved.

Method getRegisteredInterfaces return all currently registered interfaces of this environment. The memory block allocated might be slightly larger than (*pnLen*sizeof(void*)). In this method, parameter pEnv is this environment. Parameter ppInterfaces is an output parameter that is a pointer to an array of interface pointers. Parameter pnLen is an output parameter to a length of the array of interface pointers, and parameter memAlloc represents a function for allocating memory that is passed back (See Table 4).

Methods computeObjectIdentifier, acquireInterface and releaseInterface are late initialized by a matching bridge and are not for public use. Method computeObjectIdentifier computes an object id of the given interface, and is called by the environment implementation. Parameter pEnv is this environment, Parameter ppOId is an output parameter that is the computed id. Parameter pInterface is the given interface. Methods acquireInterface and releaseInterface are methods to acquire an interface, and release an interface respectively. The input parameters are defined the same as in method computeObjectIdentifier.

Table 3 is one embodiment of a generic function pointer declaration to free a proxy object, if an environment does not need the proxy object anymore. To use this function, the proxy object must register itself on the first call to method acquire( ) (See Table 1) call and revoke itself on the last call to method release((See Table 1). This can happen several times because the environment caches proxy objects until the environment explicitly frees the proxy object by calling this function. In the call to this method, parameter pEnv the environment, and parameter pProxy is the proxy pointer.

TABLE 3
One Embodiment of a Definition for
Function FreeProxyFunc

typedef void (SAL_CALL * uno_freeProxyFunc) (

uno_ExtEnvironment * pEnv, void * pProxy );

Method memAlloc (Table 4) is a generic function pointer declaration to allocate memory. This method is used with method getRegisteredInterfaces( ) (Table 2). Parameter nBytes is the amount of memory in bytes. This method returns a pointer to the allocated memory.

TABLE 4
One Embodiment of a Definition for
Function memAlloc

typedef void * (SAL_CALL * uno_memAlloc) ( sal_uInt32

nBytes );

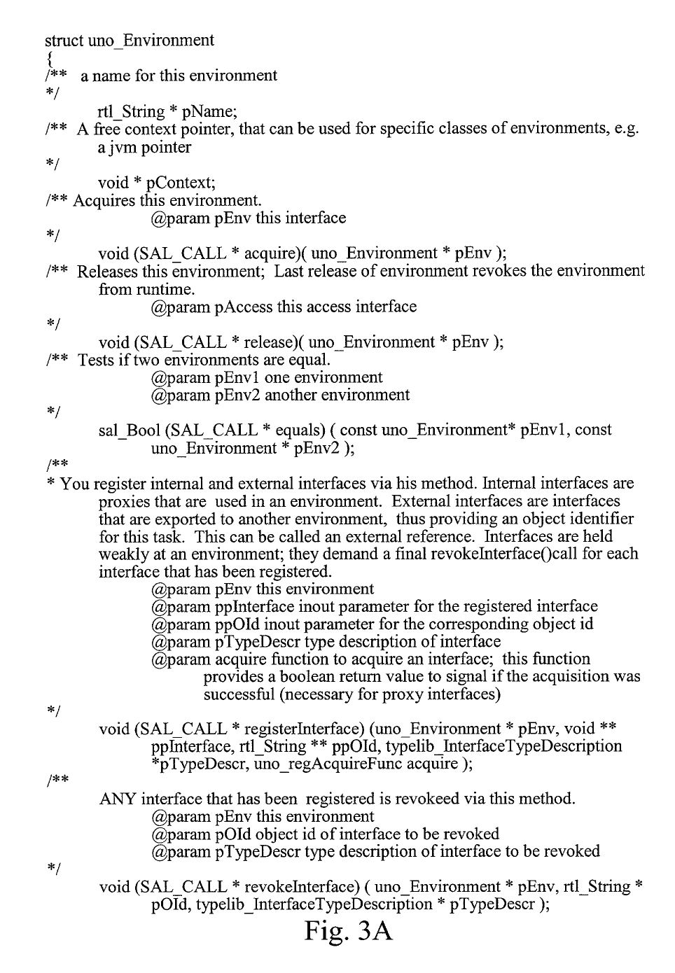

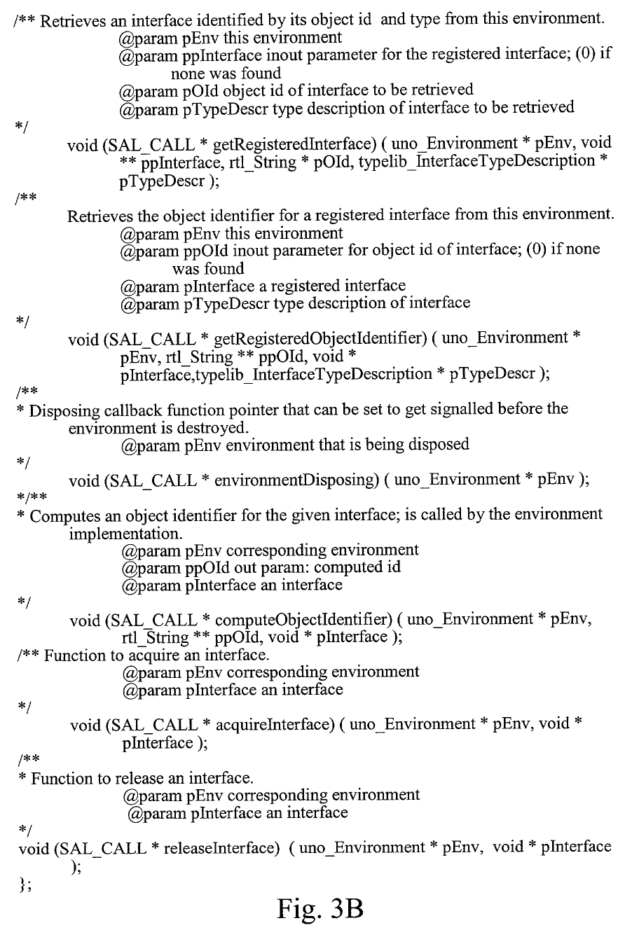

An alternative embodiment of a structure 230 for a binary specification of an execution environment is presented in FIG. 2B. In this embodiment, all the information including methods needed to manage registering and unregistering interfaces are includes in a single structure. FIGS. 3A and 3B are the information in one embodiment of structure 230. Alternatively, the information in Tables 2 and 3 could be combined into a single structure.

To use environments, the environments are registered. An existing environment is obtaining by calling a method for getting the environment. For the example of Table 1, method uno_getEnvironment( ) is used. A new environment is created by either implementing the new environment directly, or by using a simple default implementation, which is frequently also sufficient, by calling, in the given example, method uno_createDefaultEnvironment( ) with the environment's name and the environment's acquire and release functions for interfaces.

Within execution environments, type descriptions are used to map types between environments. A type description may exist or may be created at runtime. Each existing type in an execution environment is stored in a type repository along with the corresponding type description. The type descriptions are accessible through the full name of each type in the type repository, in one embodiment. For example, the full name of interface type “XInterface” may be “com.sun.star.XInterface”. The naming conventions used to access a type and/or a type description within the type repository are not an essential feature of this invention, and any suitable naming convention can be utilized. In a type repository, the types and associated type descriptions are stored in any appropriate way.

If the API (application program interface) of the type repository is a C programming language style, the type repository API is directly, that means via a binary representation, accessible from many binary specifications, and the type repository API is quickly transferable. Since the type description of each element may be used during the generic marshaling of a call, in one embodiment, C-style structures, which describe each type, are used.

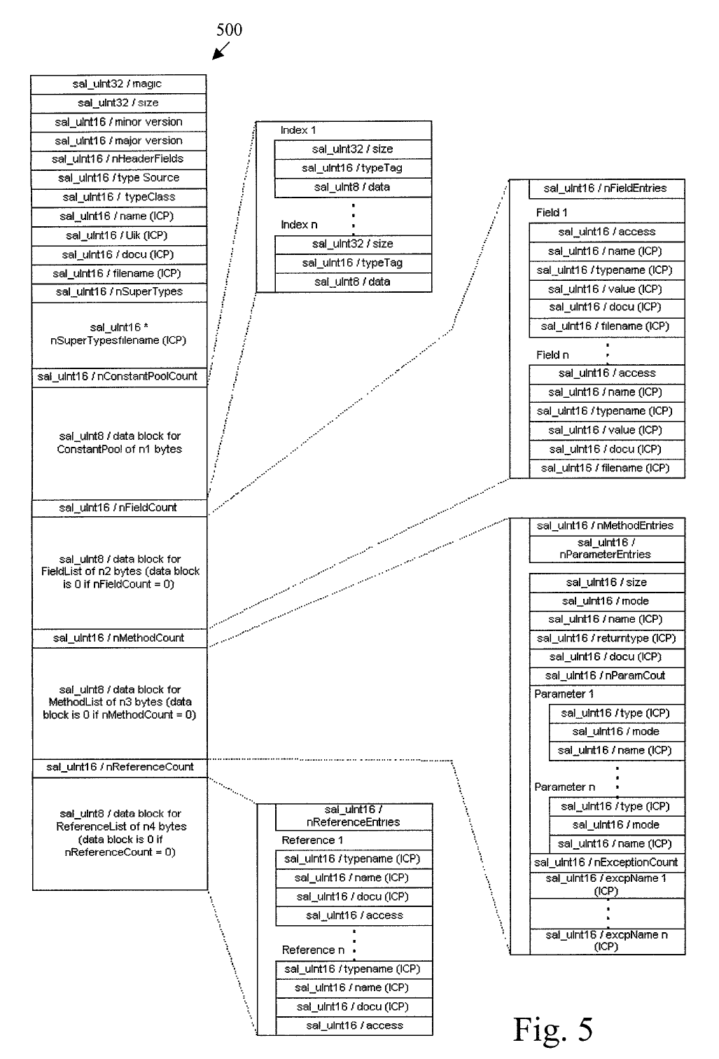

FIG. 5 is an example of a binary specification 500 of the type representation in the UNO typelibrary. The type library includes complete type descriptions for each existing IDL type. These type descriptions are organized in a hierarchical form, which represents the IDL module structure including a node for the type itself. Each type node has a binary type blob, which contains the complete type information. The structure of the type blob depends on the kind of the type. The first part is relevant for each type and the other parts depend on the type. For example, a structure has only an additional field section because it isn't possible to specify methods for structures.

In this embodiment, the structure includes a header section; a constant pool section; a field section; and a reference section. A definition of the information is each section, as illustrated in FIG. 5 is given herein.

Header Section

magic, type: sal_uInt32

a reserved field for internal use.

size, type: sal_uInt32

represents the size of the blob in bytes.

minor,major version, type: sal_uInt16

two fields to specify a version number for the binary format.

nHeaderFields, type: sal_uInt16

specifies the number of fields in the header section. This number is used for calculating the offset of the next section.

typesource, type: sal_uInt16

specifies in which language the type was defined, e.g. UNO IDL, CORBA IDL or Java.

typeclass, type: sal_uInt16

specify the typeclass of the described type, e.g. interface or enum.

name, type: sal_uInt16

represents an index for a string item in the constant item pool which specifies the full qualified name of the type.

Uik, type: sal_uInt16

represents an index for a Uik item in the constant item pool which contains the Uik information for an interface. This field is 0 if the type is not an interface.

docu, type: sal_uInt16

represents an index for a string item in the constant item pool which contains the documentation of this type.

filename, type sal_uInt16

represents an index for a string item in the constant item pool which specifies the name of the source file where the type is defined.

nSuperTypes, type: sal_uInt16

specifies the count of supertypes. This field is only relevant for structs, exceptions, services and interfaces. If nSuperTypes>0 than the next section is an area with size nSuperTypes*sal_uInt16, which represents indices for string items in the constant pool.

Constant Pool Section

The constant pool section consists of nConstantPoolCount entries of variable length and type. Each entry constists of three fields:

size, type: sal_uInt32

specifies the size of the entry in bytes

type tag, type: sal_uInt16

specifies the type of the data field.

data, type: sal_uInt8

specifies the raw data of the entry with (size−sizeof(sal_uInt32)−sizeof(sal_uInt16)) bytes.

Field Section

The field section represents type information for struct or exception members, const types, enums, service members and attributes of interfaces. This section only exists if the field nFieldCount is greater than zero.

nFieldCount, type: sal_uInt16

specifies the number of fields in the field section.

nFieldEntries, type: sal_uInt16

specifies the number of fields for each entry in the field section. This number is used for calculating the offsets in the field section.

access, type: sal_uInt16

specifies the access of the field, e.g. readonly.

name, type: sal_uInt16

represents an index for a string item in the constant item pool, which specifies the name of the field.

typename, type: sal_uInt16

represents an index for a string item in the constant item pool, which specifies the full-qualified typename of the field.

value, type: sal_uInt16

represents an index for an item in the constant item pool with the same type specified by typename which represents the value of the field, e.g., the initial enum value or the value of a constant. This field could be 0.

docu, type: sal_uInt16

represents an index for a string item in the constant item pool, which contains the documentation of this field.

filename, type: sal_uInt16

represents an index for a string item in the constant item pool, which specifies the name of the source file where the field is defined. This could be different from the filename in the header section, because constants could be defined in different source files.

Method Section

The method section represents type information for interface methods. This section only exists if the field nMethodCount is greater than zero.

nMethodCount, type: sal_uInt16

specifies the number of methods in the method section.

nMethodEntries, type: sal_uInt16

specifies the number of fields for each entry in the method section. This number is used for calculating the offsets in the method section.

nParameterEntries, type: sal_uInt16

specifies the number of fields for each entry in a parameter section. This number is used for calculating the offsets in the parameter section.

size, type: sal_uInt16

specifies the size of the current method entry in bytes.

mode, type: sal_uInt16

specifies the mode of the method, e.g., oneway.

name, type: sal_uInt16

represents an index for a string item in the constant item pool, which specifies the name of the method.

returntype, type: sal_uInt16

represents an index for a string item in the constant item pool, which specifies the full-qualified typename of the returntype of the method.

docu, type: sal_uInt16

represents an index for a string item in the constant item pool, which contains the documentation of this method.

nParamCount, type: sal_uInt16

specifies the number of parameters for this method. If parameters exist, the parameter section follows this field.

type, type: sal_uInt16

represents an index for a string item in the constant item pool, which specifies the full-qualified typename of the parameter.

mode, type: sal_uInt16

specifies the mode of the method, e.g., in, out or inout.

name, type: sal_uInt16

represents an index for a string item in the constant item pool, which specifies the name of the parameter.

nExceptionCount, type: sal_uInt16

specifies the number of exceptions for this method. If exceptions exist the exception section follows this field.

excpName 1 . . . n, type: sal_uInt16

represent indices for string items in the constant item pool, which specifies the full-qualified name of exceptions.

Reference Section

The reference section represents type information for references in services. This section only exists if the field nReferenceCount is greater than zero.

nReferenceCount, type: sal_uInt16

specifies the number of references for this type.

nReferenceEntries, type: sal_uInt16

specifies the number of fields for each entry in the reference section. This number is used for calculating the offsets in the reference section.

typename, type: sal_uInt16

represents an index for a string item in the constant item pool, which specifies the full-qualified typename of the reference.

name, type: sal_uInt16

represents an index for a string item in the constant item pool, which specifies the name of the reference.

docu, type: sal_uInt16

represents an index for a string item in the constant item pool, which contains the documentation of this reference.

access, type: sal_uInt16

specifies the access of the reference, e.g. needs, observes or interface.

In one embodiment of a type repository, all functions or type declarations have a prefix “typelib_”. In one embodiment of the type repository API, a function typelib_TypeDescription_newInterface is used to create an interface description. The descriptions of structures, unions and sequences are created with a function typelib_TypeDescription_new. The description of a base type is initially part of type repository. A function that gets a type description is function typelib_TypeDescription_getByName in the type repository API.

A JAVA API to a type repository is different for two reasons. First, the JAVA classes cannot access the binary representation of the type descriptions directly. Second, the JAVA runtime system provides an API (core reflection) similar to the type repository API. Unfortunately, the features “unsigned”, “oneway” and “out parameters” are missing in this API. For this reason, additional information is written into the JAVA classes to provide the functionality of these features.

The representation of the types depends on the hardware, the language and the operating system. The base type is swapped, for example, if the processor has little or big endian format. The size of the types may vary depending on the processor bus size. The alignment is processor and bus dependent. The alignment of the data structure is defined as follows:

Structure members are stored sequentially in the order in which the structure members are declared. Every data object has an alignment-requirement. For a structure, the alignment requirement is determined the largest object of the structure. Every object is allocated an offset so that offset % alignment-requirement==0.

If it is possible that the maximum alignment can be restricted (MICROSOFT C/C++ compiler, IBM C/C++ compiler), the maximum alignment is set to eight. Under this condition, the alignment is set to min(n, sizeof(item)) where n is maximum alignment. The size is rounded up to the largest integral base type. For the MICROSOFT and IBM C/C++ compiler the alignment of a structure is set to eight using the “#pragma” statement.

Table 5 shows the type and type definitions for one embodiment of the UNO, C++ and the JAVA execution environments.

TABLE 5

| | Environment | | |
|---|---|---|---|
| Type | UNO | C++ | JAVA |
| Byte | Signed 8 Bit | Signed 8 Bit | Signed 8 Bit |
| Short | Signed 16 Bit | Signed 16 Bit | Signed 16 Bit |
| Ushort | Unsigned 16 Bit | Unsigned 16 Bit | Signed 16 Bit |
| Long | Signed 32 Bit | Signed 32 Bit | Signed 32 Bit |
| Ulong | Unsigned 32 Bit | Unsigned 32 Bit | Signed 32 Bit |
| Hyper | Signed 64 Bit | Signed 64 Bit | Signed 64 Bit |
| Uhyper | Unsigned 64 Bit | Unsigned 64 Bit | Signed 64 Bit |
| Float | Processor | Processor | IEEE float |
| | dependent: | dependent: | |
| | Intel, Sparc = | Intel, Sparc = | |
| | IEEE float | IEEE float | |
| Double | Processor | Processor | IEEE double |
| | dependent: | dependent: | |
| | Intel, Sparc = | Intel, Sparc = | |
| | IEEE double | IEEE double | |
| Enum | The size of a | The size of a | All enum values |
| | machine word. | machine word. | of one enum |
| | Normally, this | Normally, this | declaration are |
| | is the size of | is the size of | a static object |
| | an integer. | an integer. | of a class. |
| | | | Each object |
| | | | contains a 32- |
| | | | bit value, which |
| | | | represents the |
| | | | enumeration |
| | | | value. |
| Boolean | 1 Byte. | 1 Byte. | Boolean |
| Char | 16 Bit on WNT, | 16 Bit on WNT, | Unsigned 16 bit |
| | W95, W98, and | W95, W98, and | (char) |
| | Os2. 32 Bit on | Os2. 32 Bit on | |
| | Unix | Unix | |
| String | A pointer to a | A pointer to a | java.lang.String |
| | structure which | structure which | |
| | have the | have the | |
| | following | following | |
| | members: | members: | |
| | long refCount; | long refCount; | |
| | long length; | long length; | |
| | wchar_t | wchar_t | |
| | buffer[. . .]; | buffer[. . .]; | |
| | The string in | The string in | |
| | buffer is 0 | buffer is 0 | |
| | terminated. | terminated. | |
| | This is the | This is the | |
| | rtl_wString | rtl_wString | |
| | structure in | structure in | |
| | the rtl-library | the rtl-library | |
| Structure | The structure | The structure | A class, which |
| | contains the | contains the | is derived from |
| | members in the | members in the | java.lang.Object |
| | order of the | order of the | and contains the |
| | declaration. | declaration. | members in the |
| | | | specified order. |
| Union | The size is 4 + | The size is 4 + | Not specified |
| | size of the | size of the | |
| | largest type. | largest type. | |
| | In front of the | In front of the | |
| | union members | union members | |
| | is a long value | is a long value | |
| | (nSelect), | (nSelect), | |
| | which describes | which describe | |
| | the position of | the position of | |
| | the valid | the valid | |
| | member (0 is | member (0 is | |
| | the first). | the first). | |
| Sequence | A pointer to a | A pointer to a | A normal JAVA |
| | structure which | structure which | array. |
| | has the | has the | |
| | following | following | |
| | members: | members: | |
| | void * | void * | |
| | pElements; | pElements; | |
| | long nElements; | long nElements; | |
| | long nRefCount; | long nRefCount; | |
| | The pElements | The pElements | |
| | are a memory | are a memory | |
| | area that | area that | |
| | contains | contains | |
| | nElements | nElements | |
| | elements. | elements. | |
| Exception | Looks like a | Looks like a | A class, which |
| | structure | structure | is derived from |
| | | | java.lang.Except- |
| | | | ion and contains |
| | | | the members in |
| | | | the specified |
| | | | order. |
| Interface | Is a pointer to | Is a pointer to | A normal JAVA |
| | a function | a C++-Class | interface. |
| | table, which | which | |
| | contains at | implements | |
| | least three | first the | |
| | functions. | virtual methods | |
| | | queryInterface, | |
| | | acquire and | |
| | | release. | |
| Any | A structure | A structure | A class which is |
| | that contains a | that contains a | derived from |
| | pointer to a | pointer to a | “java.lang. |
| | type | type | Object”. The |
| | description. | description. | members are a |
| | The second | The second | class, which |
| | member is a | member is a | describe the type |
| | pointer to the | pointer to the | of the value. A |
| | value stored in | value stored in | second member |
| | the any. | the any. | which is the value |
| | | | of the any. |
| Void | No memory | No memory | No memory |
| | representation | representation | representation |

Many of the types in TABLE 5 are self-explanatory and known in the art. Nevertheless, the most relevant types are explained in more detail below.

Interfaces:

All interfaces employed in connection with the present embodiment are derived from a super-interface class. Each interface contains at least three methods. Two methods “acquire” and “release” are necessary to control the lifetime of the interface. A third method “queryinterface” is used to navigate between different interfaces. In the UNO environment, an interface XInterface includes only these three methods. All other interfaces in the UNO environment are derived from this interface XInterface.

In a JAVA environment, for example, interfaces are mapped to JAVA interfaces, which could be normally implemented. Methods acquire and release are not mapped to the JAVA program, since these methods do not exist in the JAVA programming language The lifetimes of the proxy and the relevant information in a second JAVA program are controlled by a garbage collector, and so methods acquire and release are not needed. The JAVA programming language delivers basic types by value and non-basic types by reference. All calls are specified by value except interfaces. In a JAVA environment, all non-basic types returned or delivered through out parameters are by value, which means that the implementation must copy any non-basic types before return or deliver.

In a C++ environment, for example, interfaces are mapped to pure virtual classes. To automatically control the lifetime of interfaces a template called “Reference” is used. All return, parameter and member types are “References” (e.g.: Reference<XInterface>). The “Reference” acquires the interface when it is constructed, and releases the interface when it is destructed.

Structure:

A structure is a collection of elements. The type of each element is fixed and it cannot be changed. The number of elements is fixed.

Exceptions:

An exception is a program control construct besides the normal control flow. One major feature of exceptions is that with exceptions, implementation of the error handling is simpler. Exceptions are similar to structures since exceptions are also a collection of elements and each type of each element is fixed and cannot be changed and the number of elements is also fixed. An additional feature of exceptions is that exceptions can be thrown by a method. All exceptions, which can be thrown by a method, must be declared at the method, except for the exception RuntimeException, which always can occur. All exceptions must be derived from interface Exception in the UNO environment. (See commonly filed and commonly assigned U.S. patent application Ser. No. ______, entitled “A NETWORK PORTAL SYSTEM AND METHODS” of Matthias Hütsch, Ralf Hofmann and Kai Sommerfeld (Attorney Docket No. 4595), which is incorporated herein by reference in its entirety. If an exception is declared at a method, the method is allowed to throw all derived exceptions. The caller of a method must respond to this behavior.

In the JAVA environment, for example, all exceptions are derived from exception java.lang.Exception. The exceptions are declared at the methods. In the C++ environment, for example, the exceptions are generated as structures. An exception is thrown as an instance (e.g.: throw RuntimeException( )). At the other side, the exception should be caught as a reference ( . . . catch(RuntimeException &){. . . }).

Union:

A union contains one element. The declaration of a union specifies the possible types.

Array:

An array contains any number of elements. The type of the elements is fixed and cannot be changed.

Any:

An any contains one element. All types of elements are possible. An any contains a reference to the value and the type description of the type. With the type description, the bridge can transform the value, if necessary. In the JAVA environment, the any is, for example, represented by class Any, which contains a class as type description and a value, which is “java.lang.Object”. The basic types are wrapped to their proper classes. For example, a Boolean value is an object of the class “java.lang.Boolean”, which contains the value.

In the C++ environment, the any is represented through class Any. Each type generated by a C++ code maker implements a function “getCppuType”. This function is used to implement the template access operators “<<=” and “>>=”. These operators insert and extract the value of the any.

Sequence:

A sequence is a generic data type. A sequence contains the number of elements and the elements. In the JAVA environment, the specification of an array fulfills this specification. This is not true for the C++ environment. An array in the C++ programming language does not contain the number of elements. It is not possible to return a C++-array, e.g., Char[ ] getName( ) is not possible. It is difficult to manage the lifetime between the called and the caller, if only a pointer is returned. Therefore, in the C++ programming language, a sequence is a template with the name Sequence. The implementation contains a pointer to a structure, which contains a pointer to the elements, the number of elements and the reference count. Thus, the implementation of the template holds the binary specification. It is cheap to copy this sequence, because only the reference count is incremented.

Creating and using a Proxy Interface

With this understanding of an execution environment, and the various types that may be associated with an execution environment, a description of making and using one embodiment of a bridge including a proxy interface is now described. A bridge includes two mappings. Each mapping is dependent upon the counterpart mapping, because performing a call may require conversion of interfaces from one environment to the other environment, e.g., input parameters to an interface, and/or return values from an interface. Thus, a bridge implements infrastructure to exchange interfaces between two environments and is bi-directional.

FIG. 4 is a sequence diagram for one embodiment the present invention. Along the horizontal axis are individual objects, where each object is represented as a labeled rectangle. For convenience, only the objects needed to explain the operation are included. The vertical axis represents the passage of time from top to bottom of the page. Horizontal lines represent the passing of messages between objects. A dashed line extends down from each rectangle, and a rectangle along the dashed line represents the lifetime of the object.

To make calls to a first binary specification for an execution environment, the execution environment has to be denominated. In one embodiment, an execution environment is denominated by a string, because the string is extensible and the risk of double names is low. Example of strings used to denominate execution environments are presented in Table 6.

TABLE 6
EXAMPLES OF STRINGS USED TO DENOMINATE
EXECUTION ENVIRONMENTS

| LANGUAGE BINDING OR OBJECT MODEL | NAMING |
|---|---|
| Binary UNO | uno |
| JAVA | java |
| MICROSOFT C++ 4.2-6.0 | msci |
| EGCS 2.9.1 with RTTI | egcs29 |
| WorkShop Compiler 5.0 | sunpro5 |
| COM | com |

Each bridge is implemented in a separate shared library that is loaded at runtime. One naming scheme of the library is a concatenation as follows:

[purpose_]SourceEnvName_DestEnvName

The optional purpose denotes the purpose of the bridge, e.g., protocolling traffic between two environments. If no purpose is given, the bridge maps interfaces from the source environment to the destination environment.

Hence, in this embodiment, user object 401 calls a method GetEnvironment, with a string denominating the source environment as a parameter, in runtime library 402. In response to the call, a source environment object 403 is instantiated and registered by runtime library 402.

User object 401 calls a method GetEnvironment, this time with a string denominating the destination environment as a parameter, in runtime library 402. In response to this call, a destination environment object 404 is instantiated and registered by runtime library 402.

Next, user object 401 calls a method getMapping in runtime library 402. A first parameter in the method call is the string denominating the source environment. A second parameter in the method call is the string denominating the destination environment.

In response to the call to method getMapping, a bridge object 405 is activated by runtime library 402. In one embodiment, a shared library is searched to find a library that contains a proxy factory for the specified source and destination environments. In a JAVA execution environment, the search is for a class with a name associated with the source and destination environments. The shared bridge library cannot be unloaded while any of its code is still needed. So both mappings and any wrapped interface (proxy) that are exported need to modify a shared bridge library wide reference count. If the shared bridge library can be unloaded the reference count goes to zero.

After bridge object 405 is activated, user object 401 issues a call to a method Mapping.mapInterface with a first parameter that is a source interface, and a second parameter that is a type. After receiving the call to method Mapping.mapInterface, bridge object 405 issues a call to method sourceEnv.getObjectIdentifier of source environment object 403 for the type. An object identifier is returned for the type, e.g., for an interface, and bridge object 405 issues a call to method destEnv.getRegisteredInterface of destination environment object 404 with the object identifier and the type as input parameters.

If a proxy interface is registered in destination environment object 404 for this object identifier and type, a pointer to the proxy is returned by method getRegisteredInterface. In this example, a pointer to the proxy interface 406 is returned to user object 401.

Conversely, if method getRegisteredInterface failed to find a registered proxy interface, bridge object 405 calls method create proxy with a source environment and a type as input parameters. In creating a proxy, bridge object 405, in one embodiment, uses a proxy factory to generate method code to implement each method specified in the interface to be created. The only information to do this is a type description of the interface. For example, in a JAVA environment, a binary class file (*.class) is generated and loaded with the class loader. In the absence of a loader, which can directly load binary classes, a loader has to be provided. In a C++ environment, virtual method tables are generated, which delegate each call to the interface in the source environment.

The knowledge of the type description is necessary to create the proxy, as described. This type description is the full description of the limited functionality, e.g., a description of an interface, in the source execution environment. The type description may refer one of the different types shown in Table 5.

Following creation of the proxy, bridge object 405 registers the interface with source environment object 403 and registers the proxy interface with destination environment object 404. This completes creation of proxy interface 406, sometimes called proxy 406.

To use proxy interface 406, user object 401 simply calls a method in proxy interface 406. In response to the call, proxy interface 406 converts any input parameters as necessary using the method type description, and marshals the arguments for source interface 407. Next, proxy interface 406 dispatches a call to the method in source interface 407 in the source execution environment.

The method is executed in the source environment and the results are returned by source interface 407 to proxy interface 406. Upon receiving a return for the call, proxy interface 406 checks for any exceptions and if there are none, converts any output parameters and the return value to the destination execution environment again using the method type description, and then returns the results to user object 401. Thus, user object 401 has transparently accessed functionality in another execution environment. Typically, this is limited functionality, as described above.

In the following description, a specific example of a bridge that maps an interface from a MICROSOFT Visual C++ environment to a UNO environment is first described, and that maps an interface from a UNO environment to a MICROSOFT Visual C++ environment is described second. Table 7 is an example of a call to a method bar in the UNO interface XExample from a C++ program.

TABLE 7
EXAMPLE of C++ PROGRAM SEGMENT TO GENERATE
and USE A PROXY

Mapping aMapping ( “uno”, “msci” );
XExample * pExample = (XExample *)

aMapping.mapInterface ( pUnoExample,
::getCppuType( (const Reference < XExample > *) 0
) );

. . .
pExample->bar( );
. . .
pExample->release;

For the example of Table 7, the initial call to function Mapping creates a bridge from the UNO environment to the MSCI environment. The generation of the bridge, in this example uses, methods initEnvironment and getMapping. Table 8 is the implementation of these methods that are used in the proxy class of Table 9, for this example.

TABLE 8
EXAMPLE OF DECLARATION OF METHODS
initEnvironment and getMapping.

extern “C” SAL_DLLEXPORT void SAL_CALL

uno_initEnvironment( uno_Environment * pCppEnv )

{
CPPU_CURRENT_NAMESPACE::cppu_cppenv_initEnvironment(

pCppEnv );

}
extern “C” SAL_DLLEXPORT void SAL_CALL

uno_ext_getMapping( uno_Mapping ** ppMapping,
uno_Environment * pFrom, uno_Environment * pTo )

{
CPPU_CURRENT_NAMESPACE::cppu_ext_getMapping( ppMapping,

pFrom, pTo );

}

As explained above, to process a call to a method of a UNO interface in the C++ environment, there must be a proxy C++ object that delegates the method call to the corresponding UNO interface. Table 9 is bridge header file example of a bridge class, a C++ to UNO proxy class, and a UNO to C++ proxy class that can be modified for a specific environment. This example uses the bridge object and C++ to UNO proxy object that are instantiated using the classes in Table 9. As explained above, the call to method Mapping.mapInterface creates a proxy interface.

TABLE 9
EXAMPLE OF A CLASS DEFINITIONS

namespace CPPU_CURRENT_NAMESPACE
{
// these have to be defined in some C file in the
// current namespace (See Tables 10 & 16)
void SAL_CALL cppu_cppInterfaceProxy_patchVtable(

::com::sun::star::uno::XInterface * pCppI,
typelib_InterfaceTypeDescription * pTypeDescr );

void SAL_CALL cppu_unoInterfaceProxy_dispatch(

uno_Interface * pUnoI, const
typelib_TypeDescription * pMemberDescr, void *
pReturn, void * pArgs[ ], uno_Any ** ppException );

//==================================================
struct cppu_Bridge;
struct cppu_Mapping : public uno_Mapping
{
cppu_Bridge * pBridge;
inline cppu_Mapping( cppu_Bridge * pBridge,

uno_MapInterfaceFunc fpMap );

};
//==== holding environments and mappings ===================
struct cppu_Bridge
{

| | |
|---|---|
| oslInterlockedCount | nRef; |
| uno_ExtEnvironment * | pCppEnv; |
| uno_ExtEnvironment * | pUnoEnv; |
| cppu_Mapping | aCpp2Uno; |
| cppu_Mapping | aUno2Cpp; |
| sal_Bool | bExportCpp2Uno; |

void SAL_CALL acguire( );
void SAL_CALL release( );
inline cppu_Bridge( uno_ExtEnvironment * pCppEnv_,

uno_ExtEnvironment * pUnoEnv_, sal_Bool
bExportcpp2Uno_{—} );

};
//==== a cpp proxy wrapping an uno interface ==================
struct cppu_cppInterfaceProxy : public

::com::sun::star::uno::XInterface

{

| | |
|---|---|
| oslInterlockedCount | nRef; |
| cppu_Bridge * | pBridge; |
| // mapping information | |

| | |
|---|---|
| uno_Interface * | pUnoI; // wrapped interface |

typelib_InterfaceTypeDescription * pTypeDescr;

| | |
|---|---|
| ::rtl::OUString | oid; |

// non virtual methods called on incoming vtable calls

| | |
|---|---|
| // | #1, #2 |

inline void SAL_CALL acquireProxy( );
inline void SAL_CALL releaseProxy( );
// XInterface: these are only here for dummy, there

will be a patched vtable!

// dont use this, use cppu_queryInterface( )!
virtual ::com::sun::star::uno::Any SAL_CALL

queryInterface( const ::com::sun::star::uno::Type
& ) { return ::com::sun::star::uno::Any( ); }

// dont use this, use cppu_acquire( )!
virtual void SAL_CALL acquire( ) { }
// dont use this, use cppu_release( )!
virtual void SAL_CALL release( ) { }
// ctor
inline cppu_cppInterfaceProxy( cppu_Bridge * pBridge_,

uno_Interface * pUnoI_,
typelib_InterfaceTypeDescription * pTypeDescr_,
const ::rtl::OUString & rOId_{—} );

};
//= a uno proxy wrapping a cpp interface =======================
struct cppu_unoInterfaceProxy : public uno_Interface
{

| | |
|---|---|
| oslInterlockedCount | nRef; |
| cppu_Bridge * | pBridge; |
| // mapping information | |
| ::com::sun::star::uno::XInterface * | pCppI; // |

wrapped interface

typelib_InterfaceTypeDescription * pTypeDescr;

| | |
|---|---|
| :rtl::OUString | oid; |

// ctor
inline cppu_unoInterfaceProxy( cppu_Bridge * pBridge_,

::com::sun::star::uno::XInterface * pCppI_,
typelib_InterfaceTypeDescription * pTypeDescr_,
const ::rtl::OUString & rOId_{—} );

};
//-----------------------------------------------------------------------------------------
inline void SAL_CALL cppu_cppenv_initEnvironment(

uno_Environment * pCppEnv );

//-----------------------------------------------------------------------------------------
inline void SAL_CALL cppu_ext_getMapping( uno_Mapping

** ppMapping, uno_Environment * pFrom,
uno_Environment * pTo );

}

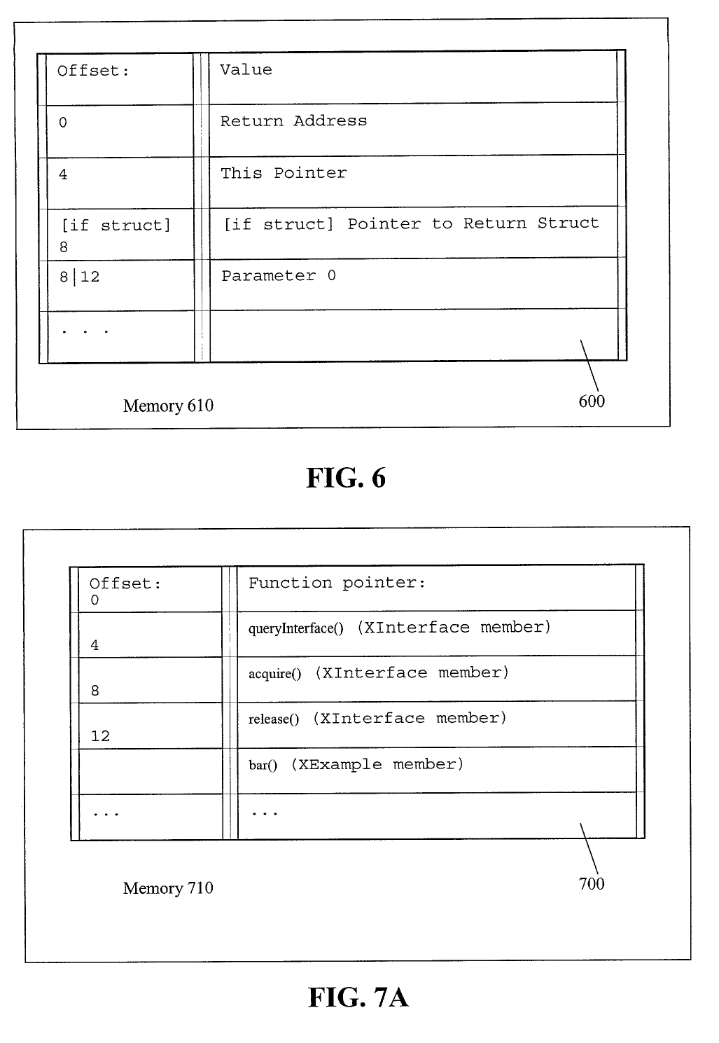

The proxy object is instantiated and the vtable pointer is modified to give a generic vtable. For a MICROSOFT C++ environment, the generic vtable can be used because an objects' this pointer is at anytime the second stack parameter (See FIG. 6). However, for gcc or sunpro5 (See Table 6), the first parameter may the pointer to a struct return space. Thus, for there compilers, a vtable for each type that is used must be generated.

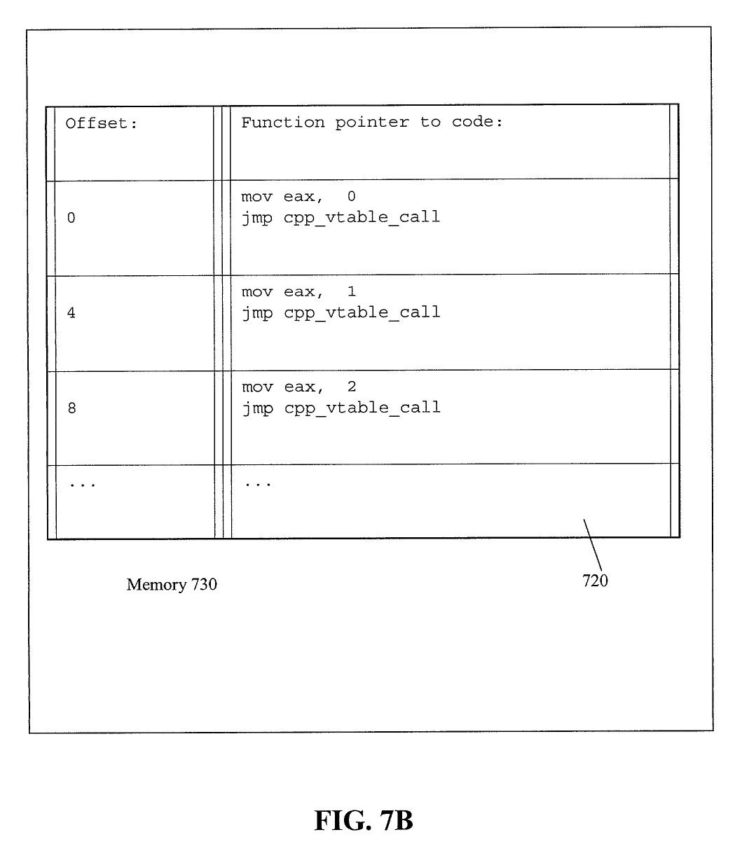

As explained more completely below, when the proxy interface is called, a vtable index is determined by the generic vtable (See FIGS. 7A and 7B), and based upon this index, the method type description is determined. This method type description is the information that is used to get the values from the processor call stack and perform a dispatch call on the target UNO interface that the C++ proxy is wrapping.

After the dispatch call, the returned exception information is checked to determine whether a C++ exception has to be generated and raised. If no exception has occurred, the inout/out parameters are reconverted. In this example, the reconversion of inout/out parameters is only important for values representing interfaces or values containing interfaces, because the values of all objects in the UNO environment are binary compatible on a specific computing architecture.

The C++ proxy, as defined by Table 9, holds the interface origin, i.e., the target UNO interface. Thus, the C++ proxy can register with the C++ environment on the first execution of method acquire, and can revoke itself on its last execution of method release from its environment.

The C++ proxy manages a reference count for the proxy, a pointer to the bridge of the C++ proxy to obtain the counterpart mapping, the UNO interface the C++ proxy delegates calls to, the (interface) type the C++ proxy is emulating, and an object identifier (oid). The type and object identifier are needed to manage objects from environments, for proof of object identity, and to improve performance. A proxy to an interface is not needed if there is already a registered proxy for that interface.

When the proxy object is created by the MICROSOFT Visual C++ compiler, the vtable is patched by the execution of method patchvtable. One embodiment of method patchvtable is presented in TABLE 10.

TABLE 10
EXAMPLE OF METHOD patchVtable

void SAL_CALL cppu_cppInterfaceProxy_patchVtable(

XInterface * pCppI,
typelib_InterfaceTypeDescription * pTypeDescr )

{
static MediateVtables * s_pMediateVtables = 0;
if (! s_pMediateVtables)
{
MutexGuard aGuard( Mutex::getGlobalMutex( ) );
if (! s_pMediateVtables)
{
#ifdef LEAK_STATIC_DATA

s_pMediateVtables = new MediateVtables( );

#else

static MediateVtables s_aMediateVtables;
s_pMediateVtables = &s_aMediateVtables;

#endif
}
}
*(const void **)pCppI = s_pMediateVtables-

>getMediateVtable( pTypeDescr-
>nMapFunctionIndexToMemberIndex );

}

An embodiment of the class MediateVtables that is used to instantiate the object MediateVtables in method patchVtable is presented in TABLE 11.

TABLE 11
EXAMPLE OF CLASS MediateVtables

class MediateVtables
{
//-------------------------------------------------------
struct DefaultRTTIEntry
{
sal_Int32 _n0, _n1, _n2;
type_info * pRTTI;
DefaultRTTlEntry ()
: _n0( 0 ),
_n1( 0 ),
_n2( 0 )
{ _pRTTI msci_getRTTT ( “com.sun.star.uno.XInterface”
); }
};
typedef list<void * > t_pSpacesList;

| | |
|---|---|
| Mutex | _aMutex; |

| | |
|---|---|
| t_pSpacesList | _aSpaces; |
| sal_Int32 | _nCurrent; |
| const void * | _pCurrent; |
| public: | |
| const void * | getMediateVtable( sal_Int32 |
| nSize ); | |

MediateVtables( sal_Int32 nSize = 256 )

: _nCurrent ( 0 )
, _pCurrent( 0 )
{ getMediateVtable ( nSize ); }

```
    ˜MediateVtables ();
};
//-----------------------------------------------------------------------------
MediateVtables: : ˜MediateVtables ()
{
TRACE( “> calling ˜MediateVtables() : freeing mediate
    vtables. . . <\n” )
MutexGuard aGuard( _aMutex );
// this MUST be the absolute last one, which is called!
for ( t_pSpacesList::iterator iPos( _aSpaces.begin() );
    iPos != aSpaces.end(); ++iPos )
{
rtl_freeMemory( *iPos );
}
}
```

TABLE 12 is an example of one embodiment of a method getMediateVtable that is called in the embodiment of method patchVtable of TABLE 10.

TABLE 12
EXAMPLE OF METHOD getMediateVtable

```
const void * MediateVtables::getMediateVtable(
    sal_Int32 nSize )
{
if (_nCurrent < nSize)
{
    TRACE( “> need larger vtable! <\n”);
// dont ever guard each time, so ask twice when guarded
MutexGuard aGuard( _aMutex );
if (_nCurrent < nSize)
{
nSize = (nSize +1) & Oxfffffffe;
char * pSpace = (char *)rtl_allocateMemory(
    ((1+nSize)*sizeof (void *)) + (nSize*12) );
aSpaces.push_back( pSpace );
// on index −1 write default rtti entry
static DefaultRTTlEntry s_defaultInterfaceRTTI;
*(void **)pSpace = &s_defaultInterfaceRTTI;
void ** pvft = (void **) (pSpace + sizeof (void *))
char * pCode = pSpace + ((1+nSize)*sizeof (void *));
// setup vft and code
for ( sal_Int32 nPos = 0; nPos < nSize; ++nPos )
{
unsigned char * codeSnip = (unsigned char *)pCode +
    (nPos *12)
pvft [nPos] = codeSnip;
/**
* vtable calls detonate on these code snippets
*/
// mov eax, nPos
*codeSnip++ = 0xb8;
*(sal_Int32 *)codeSnip = nPos;
codeSnip += sizeof(sal_Int32);
// jmp re132 cpp_vtable_call
*codeSnip++ = 0xe9;
*(sal Int32 *)codeSnip = ((unsigned char
    *)cpp_vtable_call) - codeSnip - sizeof(sal_Int32);
}
_pCurrent = pSpace + sizeof (void *);
_nCurrent = nSize;
}
}
return _pCurrent;
}
```

FIG. 6 is an example of a call stack 600 of a virtual function call that is stored in a memory 610 of computer system 100 (FIGS. 1A and 1B). The left-hand column is the stack offset for the start of storage location, and the right hand column gives the value stored at each storage location.

The vtable for the C++ proxy, i.e., a function pointer array to perform polymorphic calls on C++ objects, determines which function should be called. FIG. 7A is an illustration of the vtable for this example that correlates the slots in the table to the methods handled by the C++ proxy. Recall, that every proxy has to inherit the methods from UNO interface XInterface, which are methods acquire, release, and queryInterface.

When the call to method bar (Table 7) is executed, the call is directed to the C++ proxy. The only task of the proxy vtable is to determine the call index of the UNO method that is to be called. (See FIG. 7B).

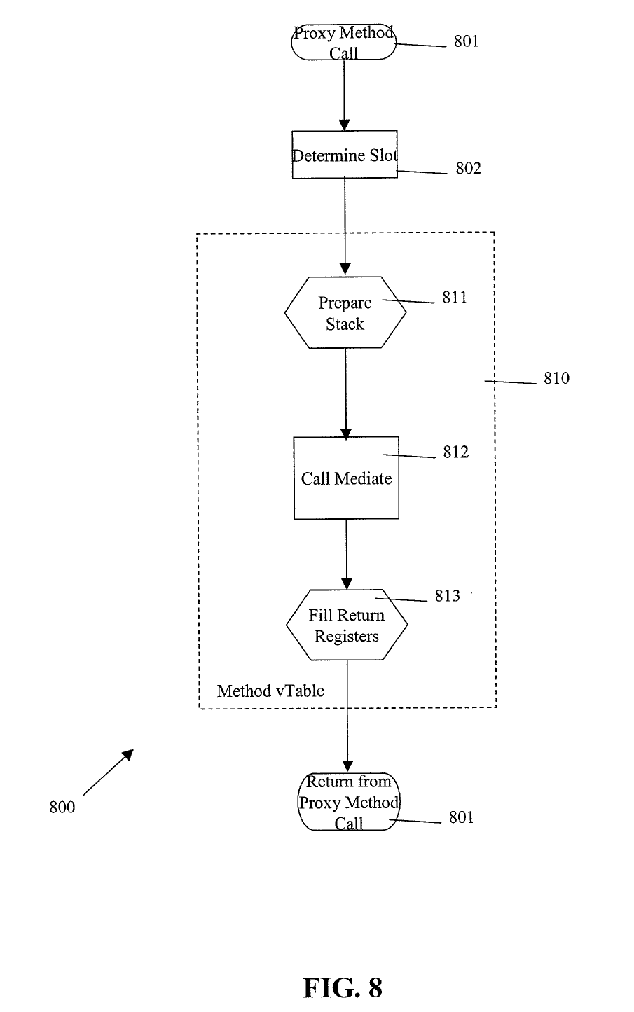

FIG. 8 is a process flow diagram of one embodiment of the operations performed by a proxy 130 or 130A that in this example is the C++ proxy. When method bar is called, process 800 (FIG. 8) is started in operation 801.

Initially, in determine slot operation 802 the C++ proxy executes method patchvtable (See Table 10) that in turn calls method getMediateVtable (See Table 12). Method getMediateVtable reaches an assembler snippet that determines the vtable slot of method bar and calls method vTable 810. This completes operation 802.

TABLE 13 is an example of one implementation of method vTable 810.

TABLE 13
AN EXANPLE OF METHOD vTable

```
/**
* is called on incoming vtable calls
* (called by asm snippets)
*/
static _declspec(naked) void _cdecl
    cpp_vtable_call (void)
{
_asm
    {
```

| | | |
|---|---|---|
| sub | esp, 8 | // space for |

immediate return type

| | |
|---|---|
| push esp | |
| push eax | // vtable index |

| | |
|---|---|
| may | eax, esp |
| add | eax, 16 |

| | |
|---|---|
| push eax | // original stack ptr |

| call cpp_mediate | |
|---|---|
| add | esp, 12 |
| cmp | eax, typelib_TypeClass_FLOAT |
| je | Lfloat |
| cmp | eax, typelib_TypeClass_DOUBLE |
| je | Ldouble |
| cmp | eax, typelib_TypeClass_HYPER. |
| je | Lhyper |
| cmp | eax, |

typelib_TypeClass_UNSIGNED_HYPER

| je | Lhyper |
|---|---|
| // rest is eax | |
| pop | eax |
| add | esp, 4 |
| ret | |

Lhyper:

| | |
|---|---|
| pop | eax |
| pop | edx |
| ret | |

Lfloat:

| | |
|---|---|
| fid | dword ptr [esp] |
| add | esp, 8 |
| ret | |

Ldouble:

| | |
|---|---|
| fid | qword ptr [esp] |
| add | esp, 8 |
| ret | |

}

}

Operation 802 transfers processing to prepare stack operation 811 in method mediate 810. In operation 811, the stack space is prepared for register data, and then processing passes to call mediate operation 812.

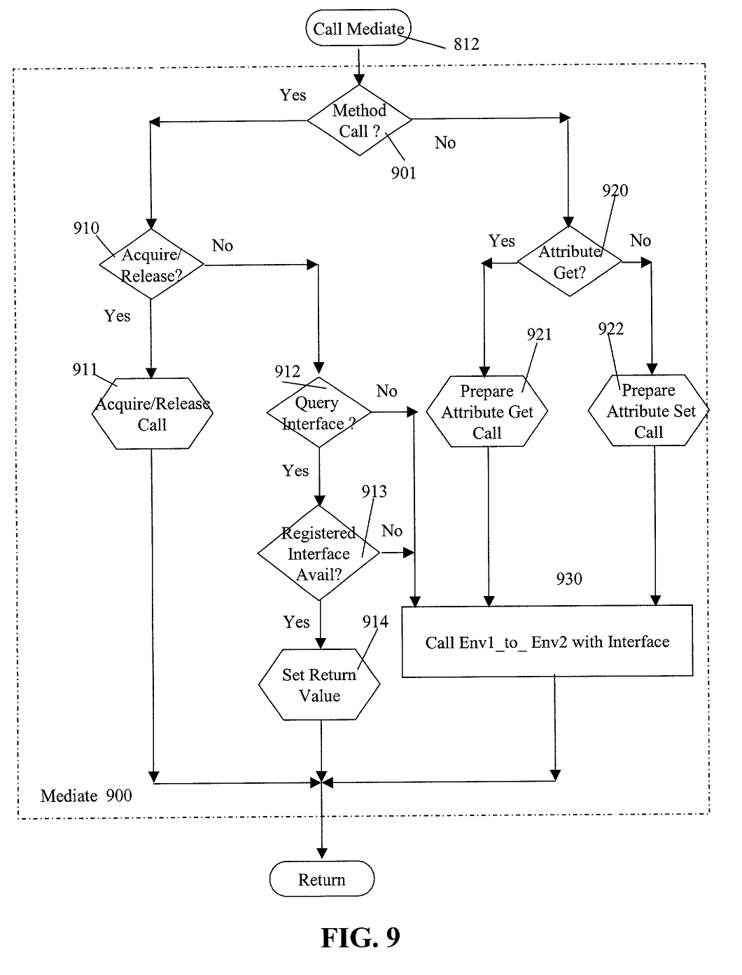

Call mediate operation 812 calls method mediate that in turn looks up the called vtable index, gets the attribute or method type description, and calls a method that dispatches that actual call to the method in the UNO environment. A process flow diagram of one embodiment of method mediate 900 is presented in FIG. 9. Table 14 is an example of method mediate.

TABLE 14
EXAMPLE OF METHOD mediate

```
static typelib_TypeClass _cdecl cpp_mediate( void **
    pCallStaCk, sal_Int32 nVtableCall, sal_Int64 *
    pRegisterReturn /* space for register return */ )
{
OSL_ENSHURE( sizeof(sal_Int32)==sizeof (void *), “###
    unexpected!”);
// pCallStack: ret adr, this, [ret *], params
// _this_ ptr is patched cppu_XInterfacePrOxy object
cppu_cppInterfaceProxy * pThis = static_cast<
    cppu_cppInterfaceProxy * >( reinterpret_cast<
    XInterface * >( pCallstack[1] ) );
typelib_InterfaceTypeDescription * pTypeDescr = pThis -
    >pTypeDescr;
OSL_ENSHURE( nVtableCall < pTypeDescr-
    >nMapFunctionIndexToMemberIndex, “### illegal
    vtable index!” );
if (nVtableCall >= pTypeDescr-
    >nMapFunctionIndexToMemberIndex)
{
throw RuntimeExceptiOfl( OUString(
    RTL_CONSTASCII_USTRINGPARAM(“illegal vtable
    index!”) ), (XInterface *)pThis );
}
// determine called method
sal_Int32 nMemberPos = pTypeDescr
    >pMapFunctionIndexToMemberIndex [nVtableCall];
OSL_ENSHURE( nMemberPos < pTypeDescr−>nAllMembers, “###
    illegal member index!” );
TypeDescription aMemberDescr ( pTypeDescr-
    >ppAllMembers [nMemberPos] );
typelib_TypeClass eRet;
switch (aMemberDescr.get () −>eTypeClass)
{
case typelib_TypeClass_INTERFACE_ATTRIBUTE:
{
if (pTypeDescr-
    >pMapMemberIndexToFunctionIndex [nMemberPos] ==
    nVtableCall)
{
// is GET method
eRet = cpp2uno_call( pThis, aMemberDescr.get (),
    ((typelib_InterfaceAttributeTypeDescription
    *)aMemberDescr.get ()) −>pAttributeTypeRef, 0, 0,
    pCallStack, pRegisterReturn );
}
else
{
// is SET method
typelib_MethodParameter aParam;
aParam.pTypeRef
    = ((type lib_InterfaceAttributeTypeDescription
    *)aMemberDescr.get ()) −>pAttributeTypeRef;
```

| | |
|---|---|
| aparam.bIn | = sal_True; |
| aparam.bOut | = sal_False; |

```
eRet = cpp2uno_call( pThis, aMemberDescr.get(),0, 1,
    &aParam, pCallStack, pRegisterReturn );
}
break;
}
case typelib_TypeClass_INTERFACE_METHOD:
{
// is METHOD
switch (nVtableCall)
{
// standard XInterface vtable calls
case 1: // acquire()
    pThis−>acquireProxy(); // non virtual call!
    eRet = typelib_TypeClass_VOID;
    break;
case 2: // release()
    pThis−>releaseProxy(); /1 non virtual call!
    eRet = typelib_TypeClass_VOID;
    break;
case 0: // queryInterface() opt
{
typelib_TypeDescription * pTD = 0;
TYPELIB_DANGER_GET( &pTD, reinterpret_cast< Type * >(
    pCallStack[3] ) −>getTypeLibType() );
OSL_ASSERT ( pTD );
XInterface * pInterface = 0;
(*pThis−>pBridge−>pCppEnv−>getRegisteredInterface) (
    pThis−>pBridge−>pCppEnv, (void **) &pInterface,
    pThis−>oid.pData,
    (typelib_InterfaceTypeDescription *)pTD );
if (pInterface)
{
uno_any_construct( reinterpret_cast< uno_Any * >(
    pCallStack[2] ), &pInterface, pTD, cpp_acquire
    );
pInterface−>release();
TYPELIB_DANGER_RELEASE ( pTD );
*(void **)pRegisterReturn = pCallStack[2];
eRet = typelib TypeClass_ANY;
break;
}
TYPELIB_DANCER_RELEASE ( pTD );
} // else perform queryInterface()
default:
eRet = cpp2uno_call(
pThis, aMemberDescr.get(),
    ((typelib_InterfaceMethodTypeDescription
    *) aMemberDescr.get () ) −>pReturnTypeRef,
    ((typelib_InterfaceMethodTypeDescription
    *) aMemberDescr.get () ) −>nParams,
    ((typelib_InterfaceMethodTypeDescription
    *) aMemberDescr.get () ) −>pParams, pCallStack,
    pRegisterReturn );
}
break;
}
default:
{
throw RuntimeException(
OUString( RTL_CONSTASCII_USTRINGPARAM(“no member
    description found!”) ), (XInterface *)pThis );
// is here for dummy
eRet = typelib TypeClass_VOID;
}
}
return eRet;
}
```

Method call check 901 of method mediate 900 determines whether the call is a method call. If the call is a method call processing transfers to acquire/release check operation 910, and otherwise to attribute get check operation 920.

Acquire/release check operation 910 branches to acquire/release call operation 911 if the method call is a call to either method acquire or method release, because these calls can be executed without calling the interface in the source environment. If the method call is not a call to either method acquire or method release, processing transfers from check operation 910 to query interface check operation 912. Acquire/Release call operation 911 performs the appropriate method, which is a non-virtual call, and returns.

Query interface check operation 912 determines whether the method call is to method queryInterface. If the method call is not to method queryInterface, check operation 912 transfers to call Env1_to_Env2 with Interface operation 930 and otherwise transfers to registered interface available check operation 913. In the current example, the call to method bar results in check operation 912 transferring to operation 930.

Nevertheless, to complete the description of this branch of method mediate 900, if there is a registered interface in the source environment object for method queryInterface, check operation 913 transfers to set return value operation 914 and otherwise to call Env1_to_Env2 with Interface operation 930. Asking whether the interface is registered in the source environment object is an optimization that eliminates a call to the actual interface in the source environment. Set return value operation 914 sets the registered interface as the return value and returns.

If the call to the C++ proxy was not a method call, check operation 901 transfers to attribute get check operation 920. In this embodiment, there is either an attribute get or an attribute set. If the call to the proxy is an attribute get, check operation 920 transfers to prepare attribute get call operation 921 and otherwise transfers to prepare attribute set call operation 922. Both operations 921 and 922 set up the parameters for the call and transfer to call Env1_to_Env2 with Interface operation 930.

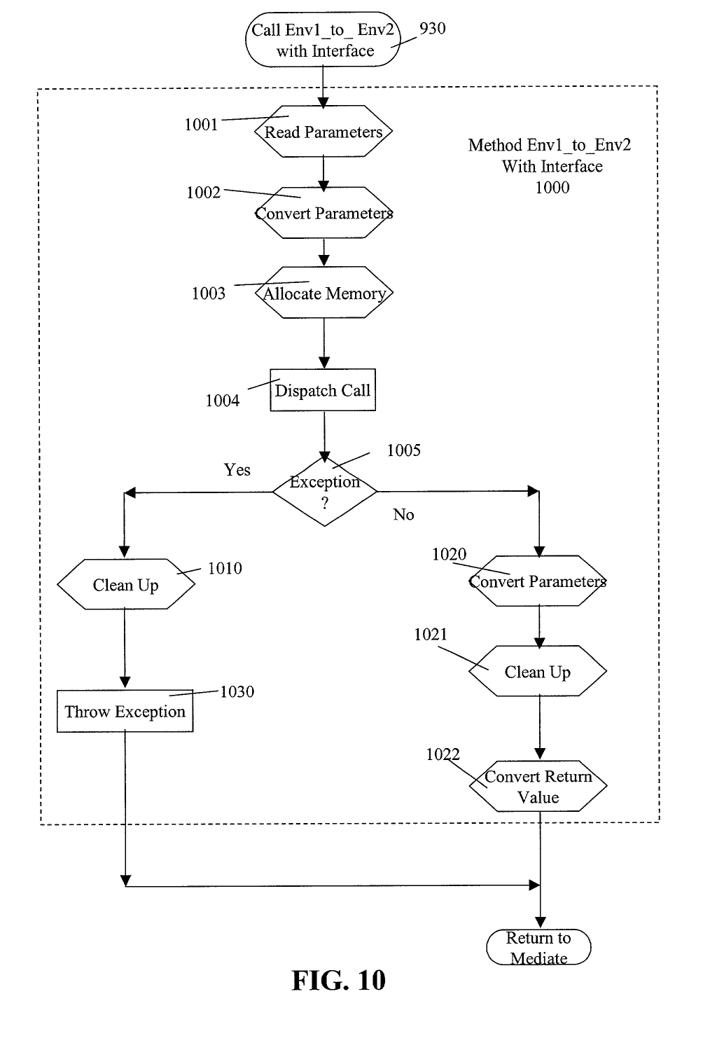

An embodiment of method Env1_to_Env2 with interface for the C++ proxy is presented in Table 15. FIG. 10 is a process flow diagram for one embodiment of method Env1_to_Env2 with interface.

TABLE 15
AN EXAMPLE OF METHOD Env1_to_Env2 with
interface

```
using namespace std;
using namespace rtl;
using namespace osl;
using namespace com::Sun::star::Uno;
namespace CPPU_CURRENT_NAMESPACE
{
static inline typelib_TypeClass cpp2uno_call(
    cppu_cppInterfaceProxy * pThis, const
    typelib_TypeDescription * pMemberTypeDescr,
    typelibTypeDescriptionReference * pReturnTypeRef,
    sal_Int32 nParams, typelib_MethodParameter *
    pParams, void ** pCallStack,
    sal_Int64 * pRegisterReturn
{
// pCallStack: ret, this, [complex return ptr], params
char * pCppStack = (char *) (pCallStack +2);
// return
typelib_TypeDescription * pReturnTypeDescr = 0;
if (pReturnTypeRef) TYPELIB_DANGER_GET(
    &pReturnTypeDescr, pReturnTypeRef );
void * pUnoReturn = 0;
// complex return ptr: if != 0 && != pUnoReturn,
// reconversion need
void * pCppReturn = 0;
if (pReturnTypeDescr)
{
if (cppu_isSimpleType( pReturnTypeDescr ))
{
// direct way for simple types
pUnoReturn = pRegisterReturn;
}
else // complex return via ptr (pCppReturn)
{
pCppReturn = *(void **)pCppStack;
pCppStack += sizeof (void *);
pUnoReturn = (cppu_relatesToInterface( pReturnTypeDescr
    )
// direct way
? alloca( pReturnTypeDescr−>nSize ) : pCppReturn);
}
}
// stack space
OSL_ENSHURE( sizeof (void *) == sizeof(sal_Int32), “###
    unexpected size!” );
// parameters
void ** pUnoArgs = (void **)alloca( 4 * sizeof (void *)
    * nParams );
void ** pCppArgs = pUnoArgs + nParams;
// indices of values that have to be converted
// (interface conversion cpp<=>uno)
sal_Int32 * pTempIndizes = (sal_Int32 *) (pUnoArgs + (2
    * nParams));
// type descriptions for reconversions
typelib TypeDescription ** ppTempParamTypeDescr =
    (typelib_TypeDescription **) (pUnoArgs + (3 *
    nParams))
sal_Int32 nTempIndizes = 0;
for ( sal_Int32 nPos = 0; nPos < nParams; ++nPos )
{
const typelib_MethodParameter & rParam = pParams [nPos];
typelib_TypeDescription * pParamTypeDescr = 0;
TYPELIB_DANGER_GET( &pParamTypeDescr, rParam.pTypeRef
    );
if (!rParam.bOut && cppu_isSimpleType( pParamTypeDescr
    )) // value
{
pCppArgs[nPos] = pCppStack;
pUnoArgs[nPos] = pCppStack;
switch (pParamTypeDescr−>eTypeClass)
{
case typelib_TypeClass_HYPER:
case typelib_TypeClass_UNSIGNED_HYPER:
case typelib_TypeClass_DOUBLE:
pCppStack += sizeof(sal_Int32); // extra long
}
// no longer needed
TYPELIB_DANGER_RELEASE( pParamTypeDescr );
}
else // ptr to complex value | ref
{
pCppArgs[nPos] = *(void **)pCppStack;
if (! rParam.bIn) // is pure out
{
// uno out is unconstructed mem!
pUnoArgs[nPos] = alloca( pParamTypeDescr−>nSize );
pTempIndizes[nTempIndizes] = nPos;
// will be released at reconversion
ppTempParamTypeDescr [nTempIndizes++] = pParamTypeDescr;
}
// is in/inout
else if (cppu_relatesToInterface( pParamTypeDescr ))
{
uno_copyAndConvertData( pUnoArgs[nPos] = alloca(
    pParamTypeDescr−>nSize ), * (void **) pCppStack,
    pparamTypeDescr, &pThis−>pBridge−>aCpp2Uno );
// has to be reconverted
pTempIndizes [nTempIndizes] = nPos;
// will be released at reconversion
ppTempParamTypeDescr [nTempIndizes++] = pParamTypeDescr;
}
else // direct way
{
pUnoArgs[nPos] = *(void **)pCppStack;
// no longer needed
TYPELIB_DANGER_RELEASE ( pParamTypeDescr );
}
}
// standard parameter length
pCppStack += sizeof(sal_Int32);
}
// ExceptionHolder
uno_Any aUnoExc; // Any will be constructed by callee
uno_Any * pUnoExc = &aUnoExc;
// invoke uno dispatch call
(*pThis>pUnoI−>pDispatcher) ( pThis−>pUnoI,
    pMemberTypeDescr, pUnoReturn, pUnoArgs, &pUnoExc
    );
// in case an exception occurred. . .
if (pUnoExc)
{
// destruct temporary in/inout params
while (nTempIndizes--)
{
sal_Int32 nIndex = pTempIndizes[nTempIndizes];
// is in/inout => was constructed
if (pParams[nIndex].bIn)
uno_destructData ( pUnoArgs [nIndex]p,
    ppTempParamTypeDescr[nTempIndizes], 0 );
TYPELIB_DANGER_RELEASE(
    ppTempParamTypeDescr[nTempIndizes] );
}
if (pReturnTypeDescr) TYPELIB_DANGER_RELEASE(
    pReturnTypeDescr );
msci_raiseException ( &aUnoExc, &pThis−>pBridge-
    >aUno2Cpp ); // has to destruct the any
// is here for dummy
return typelib_TypeClass_VOID;
}
else // else no exception occurred . . .
{
// temporary params
while (nTempIndizes--)
{
sal_Int32 nIndex = pTempIndizes [nTempIndizes];
typelib_TypeDescription * pParamTypeDescr =
    ppTempParamTypeDescr[nTempIndizes];
if (pParams[nIndex].bOut) // inout/out
{
// convert and assign
uno_destructData ( pCppArgs [nIndex], pParamTypeDescr,
    cpp_release );
uno_copyAndConvertData ( pCppArgs [nIndex],
    pUnoArgs [nIndex], pParamTypeDescr, &pThis-
    >pBridge−>aUno2Cpp );
}
// destroy temp uno param
uno_destructData( pUnoArgs [nIndex], pParamTypeDescr, 0
    );
TYPELIB_DANGER_RELEASE ( pParamTypeDescr );
}
// return
if (pCppReturn) // has complex return
{
if (pUnoReturn != pCppReturn) // needs reconversion
{
uno_copyAndConvertData ( pCppReturn, pUnoReturn,
    pReturnTypeDescr, &pThis−>pBridge−>aUno2Cpp );
// destroy temp uno return
uno_destructData( pUnoReturn, pReturnTypeDescr, 0 );
}
// complex return ptr is set to eax
*(void **)pRegisterReturn = pCppReturn;
}
if (pReturnTypeDescr)
{
typelib TypeClass eRet =
    (typelib TypeClass) pReturnTypeDescr−>eTypeClass;
TYPELIB_DANGER_RELEASE ( pReturnTypeDescr );
return eRet;
}
else
return typelib_TypeClass_VOID;
}
}
```

In FIG. 10, read parameters operation 1001 reads the parameters from the stack. All simple parameters are directly accessed on the stack (up to eight bytes). All complex structures, e.g., interfaces, are referenced by a pointer. Since in this example UNO and C++ types have the same binary size (See Table 5), only interfaces need to be exchanged.

Read parameters operation 1001 transfers to convert parameters operation 1002. Convert parameters operation 1002, using the parameter type description, converts the parameters read to the UNO environment and transfers to allocate memory operation 1003. Allocate memory operation 1003 allocates memory for the out parameters returned by the call to the UNO interface, and for the return value. Allocate memory operation 1003 transfers processing to dispatch call operation 1004.

Dispatch call operation 1004 calls, in this example, method bar in UNO interface XExample. In general, dispatch call operation 1004 dispatches a call to the source interface (See FIG. 4). The call is executed in the source environment and the results, if any, are returned to operation 1004 that in turn transfers to exception check operation 1005.

Exception check operation 1005 determines whether an exception was thrown in response to the call. If an exception was thrown, check operation 1005 transfers processing to clean up operation 1110 and otherwise processing transfers to convert parameters operation 1020.

Clean up operation 1010 cleans up any temporary parameters that were created in the call in operation 1004. Operation 1010 transfers to throw exception operation 1030 that in turn throws an exception in the destination environment based upon the exception received from the call to the source environment.

If an exception was not thrown in the source environment, convert parameters operation 1020 converts any parameters that were returned from operation 1004, e.g., out parameters and/or inout parameters using the parameter type description, from the source environment to the destination environment, and transfers to clean up operation 1021. Clean up operation 1021 cleans up any temporary parameters that were created in the call in operation 1004 and transfers to convert return value operation 1022. Operation 1022 converts any return value from the source environment to the destination environment so that both the return value and any returned parameters are written back, in this example to C++. Processing returns to mediate method 900 that in turn returns to fill return registers 813 in method vTable 810.

In fill return registers operation 813, if the type is one of float, double, hyper, or unsigned hyper, an appropriate action is taken to properly fill the return registers. Otherwise, a 32-bit integer is placed in register eax. See Table 13 for one embodiment of operation 813.

The above example assumed that the original call was in a C++ environment and was directed to a method of an interface in the UNO environment. In the embodiment of FIG. 1A, another possibility is that a call is made in the UNO environment, i.e., environment 120 to a C++ method in environment 150. In this case, the bridge and proxy would be in the UNO environment. Alternatively, in FIG. 1B, the intermediate environment is a UNO environment.

In this embodiment, struct cppu_unoInterfaceProxy in Table 9 is used to instantiate the UNO proxy that wraps a C++ interface. As explained more completely below, when the proxy interface is called, a check is made to determine if a method of the proxy interface has been called. If a method was called, any input parameters are converted using the type description and pushed on a processor stack, and then a call is dispatched to the demanded vtable slot in the source interface.

After execution of the dispatch call, the returned information is checked to determine whether a C++ exception was generated. If no exception has occurred, the inout/out parameters are reconverted. In this example, the reconversion of inout/out parameters is only important for values representing interfaces or values containing interfaces, because the values of all objects in the UNO environment are binary compatible on a specific computing architecture.

The UNO proxy, as defined by Table 9, holds the interface origin, i.e., the target C++ interface. Thus, the UNO proxy can register at with the UNO environment on the first execution of method acquire, and can revoke itself on its last execution of method release from its environment.

The UNO proxy manages a reference count for the proxy, a pointer to the bridge of the UNO proxy to obtain the counterpart mapping, the C++ interface the UNO proxy delegates calls to, the (interface) type the UNO proxy is emulating, and an object identifier (oid). The type and object identifier are needed to manage objects from environments, for proof of object identity, and to improve performance. A proxy to an interface is not needed if there is already a registered proxy for that interface.

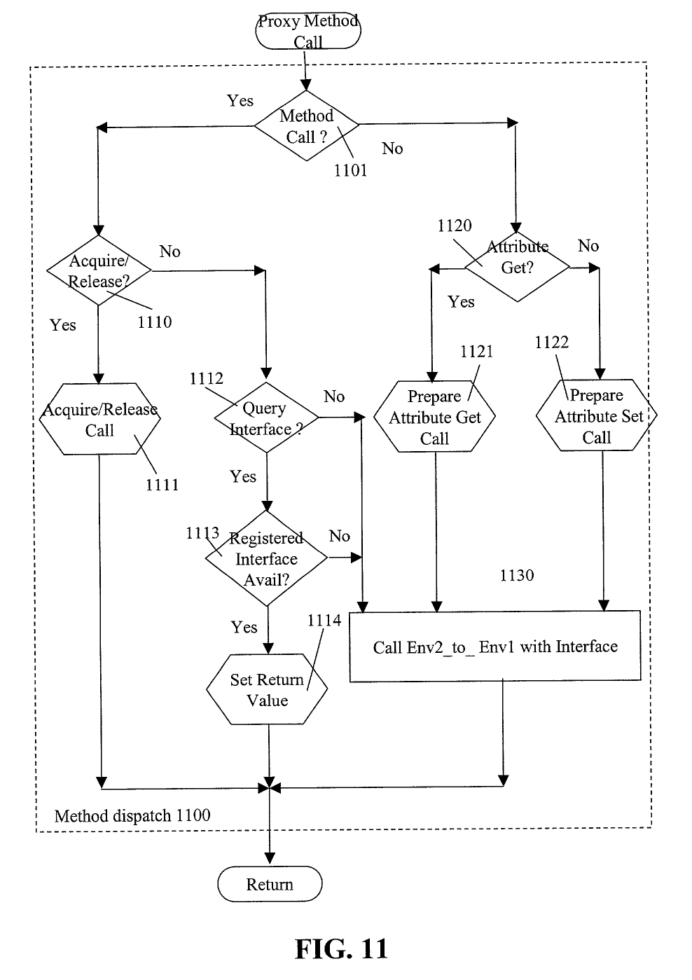

When the call to a method in the wrapped C++ interface is executed, the call is directed to the UNO proxy. FIG. 11 is a process flow diagram of one embodiment of the operations performed by the UNO proxy. One example of computer code for this embodiment is presented in TABLE 16.

TABLE 16
EXAMPLE OF A METHOD dispatch USED BY A UNO
PROXY WRAPPING A C++ INTERFACE

```
void SAL_CALL cppu_unoInterfaceProxy_dispatch(
    uno_Interface * pUnoI, const
    typelib_TypeDescription * pMemberDescr, void *
    pReturn, void * pArgs[], uno Any ** ppException )
{
// is my surrogate
cppu_unoInterfaceProxy * pThis = static_cast<
    cppuunoInterfaceProxy * >( pUnoI );
typelib_InterfaceTypeDescription * pTypeDescr = pThis-
    >pTypeDescr;
switch (pMemberDescr−>eTypeClass)
    {
case typelib_TypeClass_INTERFACE_ATTRIBUTE:
    {
// determine vtable call index
sal_Int32 nMemberPos =
    ((typelib_InterfaceMemberTypeDescription
    *)pMemberDescr) −>nPosition;
OSL_ENSHURE( nMemberPos < pTypeDescr−>nAllMembers, “###
    member pos out of range!”
sal_Int32 nVtableCall = pTypeDescr
    >pMapMemberIndexToFunctionIndex [nMemberPos];
OSL_ENSHURE( nVtableCall < pTypeDescr-
    >nMapFunctionIndexToMemberIndex, “### illegal
    vtable index!” );
typelib_TypeDescriptionReference * pRuntimeExcRef = 0;
if (pReturn)
        {
// dependent dispatch
cpp_call( pThis, nVtableCall,
    ((typelib_InterfaceAttributeTypeDescription
    *) pMemberDescr) −>pAttributeTypeRef,
      0, 0, // no params
      1, &pRuntimeExcRef, // RuntimeException
      pReturn, pArgs, ppException );
        }
else
        {
// is SET
typelib_MethodParameter aParam;
aParam.pTypeRef =
    ((typelib_InterfaceAttributeTypeDescription
    *) pMemberDescr) −>pAttributeTypeRef;
```

| | |
|---|---|
| aParam.bIn | = sal_True; |
| aParam.bOut | = sal_False; |

```
typelib_TypeDescriptionReference * pReturnTypeRef = 0;
OUString aVoidName( RTL_CONSTASCII_USTRINGPARAM(“void”)
    );
Typelib_typedescriptionreference_new (&pReturnTypeRef,
    typelib TypeClass_VOID, aVoidName.pData );
// dependent dispatch
cpp_call( pThis, nVtableCall +1, // get, then set
    method
      pReturnTypeRef,
      1, &aParam,
      1, &pRuntimeExcRef,
      pReturn, pArgs, ppException );
typelib_typedescriptionreference_release(
    pReturnTypeRef );
        }
break;
    }
case typelib_TypeClass_INTERFACE METHOD:
    {
// determine vtable call index
sal_Int32 nMemberPos =
    ((typelib_InterfaceMemberTypeDescription
    *) pMemberDescr) −>nPosition;
OSL_ENSHURE( nMemlberPos < pTypeDescr−>nAllMembers, “###
    member pos out of range!” );
sal_Int32 nVtableCall = pTypeDescr-
    >pMapMemberIndexToFunctionIndex [nMemberPos];
OSL_ENSHURE( nVtableCall < pTypeDescr-
    >nMapFunctionIndexToMemberIndex, “### illegal
    vtable index!” );
switch (nVtableCall)
      {
// standard calls
    case 1: // acquire uno interface
(*pUnoI−>acquire) ( pUnoI );
*ppException = 0;
break;
    case 2: // release uno interface
(*pUnoI−>release) ( pUnoI );
*ppException = 0;
break;
    case 0: // queryInterface() opt
        {
typelib_TypeDescription * pTD = 0;
TYPELIB_DANGER_GET( &pTD, reinterpret_cast< Type * >(
    pArgs[0] )−>getTypeLibType() );
OSL_ASSERT ( pTD );
uno_Interface * pInterface = 0;
(*pThis−>pBridge−>pUnoEnv-
    >getRegisteredInterface) (pThis−>pBridge−>pUnoEnv,
    (void **) &pInterface, pThis−>oid.pData,
    (typelib_InterfaceTypeDescription *)pTD );
if (pInterface)
        {
uno_any_construct( reinterpret_cast< uno_Any * >(
    pReturn ), &pInterface, pTD, 0 );
(*pInterface−>release) ( pInterface );
TYPELIB_DANGER_RELEASE ( pTD );
*ppException = 0;
break;
        }
TYPELIB_DANGER_RELEASE ( pTD );
      }// else perform queryInterface()
default:
// dependent dispatch
cpp_call( pThis, nVtableCall,
    ((typelib_InterfaceMethodTypeDescription
    *) pMemberDescr)−>pReturnTypeRef,
    ((typelib_InterfaceMethodTypeDescription
    *) pMemberDescr)−>nParams,
    ((typelib_InterfaceMethodTypeDescription
    *) pMemberDescr)−>pParams,
    ((typelib_InterfaceMethodTypeDescription
    *) pMemberDescr)−>nExcept ions,
    ((typelib_InterfaceMethodTypeDescription
    *)pMemberDescr)−>ppExceptions, pReturn, pArgs,
    ppException );
        }
break;
    }
default:
    {
::com::sun::star::uno::RuntimeException aExc (OUString(
    RTL_CONSTASCII_USTRINGPARAM(“illegal member type
    description!”) ) ,pThis−>pCppI );
typelib_TypeDescription * pTD = 0;
const Type & rExcType = ::getCppuType( (const
    ::com::sun::star::uno::RuntimeException *)0 );
TYPELIB_DANGER_GET( &pTD, rExcType.getTypeLibType() );
      uno_any_construct ( *ppException, &aExc, pTD,
    0 );
TYPELIB_DANGER_RELEASE ( pTD );
    }
    }
}
```

Method call check 1101 of method dispatch 1100 determines whether the call is a method call. If the call is a method call processing transfers to acquire/release check operation 1110, and otherwise to attribute get check operation 1120.

Acquire/release check operation 1110 branches to acquire/release call operation 1111 if the method call is a call to either method acquire or method release, because these calls can be executed without calling the interface in the second environment. If the method call is not a call to either method acquire or method release, processing transfers from check operation 1110 to query interface check operation 1112. Acquire/Release call operation 1111 performs the appropriate method, which is a non-virtual call, and returns.

Query interface check operation 1112 determines whether the method call is to method queryInterface. If the method call is not to method queryInterface, check operation 1112 transfers to call Env2_to_Env1 with Interface operation 1130 and otherwise transfers to registered interface available check operation 1113.

If there is a registered interface in the source environment for method queryInterface, check operation 1113 transfers to set return value operation 1114 and otherwise to call Env2_to_Env1 with Interface operation 1130. Set return value operation 1114 sets the registered interface as the return value and returns.

If the call to the C++ proxy was not a method call, check operation 1101 transfers to attribute get check operation 1120. In this embodiment, there is either an attribute get or an attribute set. If the call to the UNO proxy is an attribute get, check operation 1120 transfers to prepare attribute get call operation 1121 and otherwise transfers to prepare attribute set call operation 1122. Both operations 1121 and 1122 set up the parameters for the call and transfer to call Env2_to_Env1 with Interface operation 1130. The call is given the C++ interface pointer, a vtable index, and all parameters necessary to perform the C++ virtual function call.

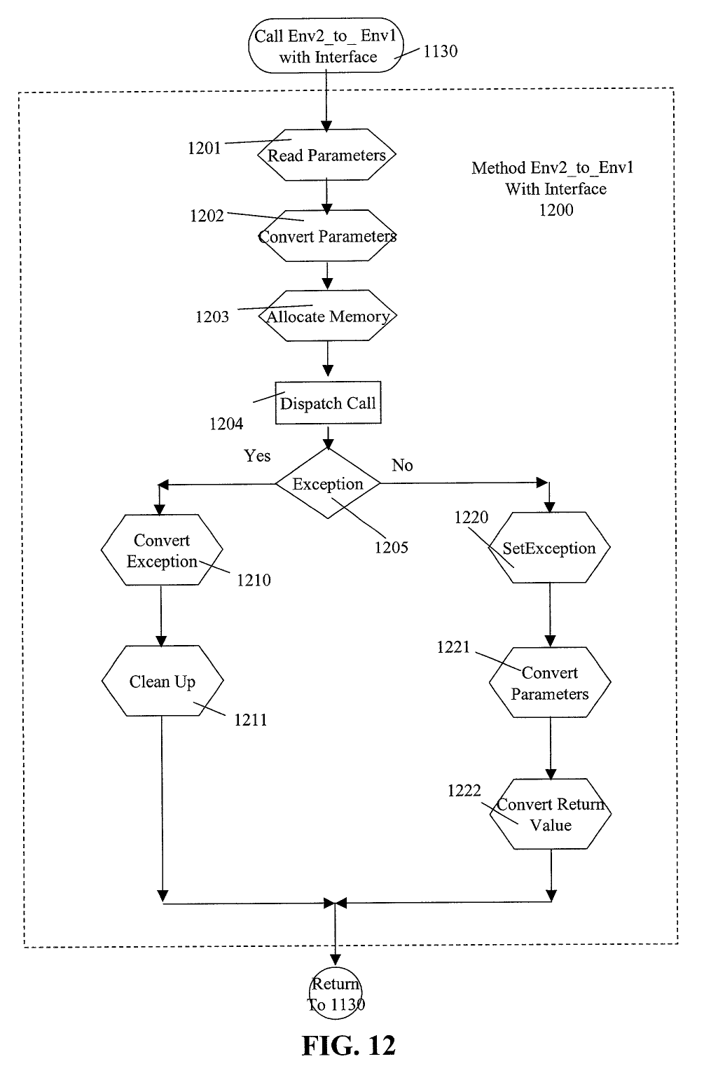

An embodiment of method Env2_to_Env1 with interface for the UNO proxy is presented in Table 17. FIG. 12 is a process flow diagram for one embodiment of method Env2_to_Env1 with interface.

TABLE 17
EXAMPLE of METHOD Env2_to_Env1 with
interface FOR THE UNO PROXY

```
namespace CPPU_CURRENT_NAMESPACE
{
inline static void cpp_call (cppu_unoInterfaceProxy *
    pThis, sal_Int32 nVtableCall,
    typelib_TypeDescriptionReference * pReturnTypeRef,
    sal_Int32 nParams, typelib_MethodParameter *
    pParams, sal_Int32 nExceptions,
    typelib_TypeDescriptionReference **
    ppExceptionRefs, void * pUnoReturn, void *
    pUnoArgs [], uno Any ** ppUnoExc
{
// max space for: [complex ret ptr], values|ptr . . .
char * pCppStack = (char *)alloca( sizeof(sal_Int32) +
    (nParams * sizeof(sal_Int64)) );
char * pCppStackStart = pCppStack;
// return
typelib_TypeDescription * pReturnTypeDescr = 0;
TYPELIB_DANGER_GET( &pReturnTypeDescr, pReturnTypeRef
    );
OSL_ENSHURE( pReturnTypeDescr, “### expected return
    type description!” );
// if != 0 && != pUnoReturn, needs reconversion
void * pCppReturn = 0;
if (pReturnTypeDescr)
{
if (cppu_isSimpleType( pReturnTypeDescr ))
{
pCppReturn = pUnoReturn; // direct way for simple types
}
else
{
// complex return via ptr
// direct way
pCppReturn = *(void **)pCppStack =
    (cppu_relatesToInterface( pReturnTypeDescr ) ?
    alloca( pReturnTypeDescr−>nSize ) :pUnoReturn);
pCppStack += sizeof (void *);
}
}
// stack space
OSL_ENSHURE( sizeof (void *) == sizeof(sal_Int32), “###
    unexpected size!” );
// args
void ** pCppArgs = (void **)alloca( 3 * sizeof (void *)
    * nParams );
// indices of values thats have to be converted
//  (interface conversion cpp<=>uno)
sal_Int32 * pTempIndizes = (sal_Int32 *) (pCppArgs +
    nParams );
// type descriptions for reconversions
typelib_TypeDescription ** ppTempParamTypeDescr =
    (typelib_TypeDescription **) (pCppArgs + (2 *
    nparams));
sal_{—l Int32 nTempIndizes = 0;}
for ( sal_Int32 nPos = 0; nPos < nParams; ++nPos )
{
const typelib_MethodParameter & rParam = pParams [nPos];
typelib_TypeDescription * pParamTypeDescr = 0;
TYPELIB_DANGER_GET( &pParamTypeDescr, rParam.pTypeRef
    );
if (!rParam.bOut && cppu_isSimpleType ( pparamTypeDescr
    ))
{
uno_copyAndConvertData( pCppArgs[nPos] = pCppStack,
    pUnoArgs [nPos], pParamTypeDescr, &pThis−>pBridge-
    >aUno2Cpp );
switch (pParamTypeDescr−>eTypeClass)
{
case typelib_TypeClass_HYPER:
case typelib_TypeClass_UNSIGNED_HYPER:
case typelib_TypeClass_DOUBLE:
pCppStack += sizeof(sal_Int32); // extra long
}
// no longer needed
TYPELIB_DANGER_RELEASE ( pParamTypeDescr );
}
else // ptr to complex value | ref
{
if (! rParam.bIn) // is pure out
{
// cpp out is constructed mem, uno out is not!
uno_constructData( *(void **)pCppStack =
    pCppArgs[nPos] = alloca( pParamTypeDescr−>nSize ),
    pParamTypeDescr );
pTempIndizes [nTemplndizes] = nPos;
// default constructed for cpp call
// will be released at reconversion
ppTempParamTypeDescr [nTempIndizes++] = pParamTypeDescr;
}
// is in/inout
else if (cppu_relatesToInterface( pParamTypeDescr ))
{
uno_copyAndConvertData( *(void **)pCppStack =
    pCppArgs[nPos] = alloca( pParamTypeDescr−>nSize ),
    pUnoArgs[nPos], pParamTypeDescr, &pThis−>pBridge-
    >aUno2Cpp );
pTempIndizez [nTempIndizes] = nPos;
// has to be reconverted
// will be released at reconversion
ppTempParamTypeDescr [nTempIndizes++] = pparamTypeDescr;
}
else // direct way
{
*(void **)pCppStack = pCppArgs[nPos] = pUnoArgs[nPos];
// no longer needed
TYPELIB_DANGER_RELEASE ( pParamTypeDescr );
}
}
pCppStack += sizeof(sal_Int32); // standard parameter
    length
}
// only try-finally/ try-except statements possible. . .
_try
{
_try
{
// pCppI is msci this pointer
callVirtualMethod ( pThis −>pCppI, nVtableCall,
    pCppReturn, pReturnTypeDescr−>eTypeClass,
    (sal_Int32 *)pCppStackStart, (pCppStack -
    pCppStackStart) / sizeof(sal_Int32) );
// NO exception occured. . .
*ppUnoExc = 0;
// reconvert temporary params
while (nTempIndizes--)
{
sal_Int32 nIndex = pTempIndizes [nTemplndizes];
typelib_TypeDescription * pParamTypeDescr =
    ppTempParamTypeDescr [nTempIndizes];
if (pParams [nIndex].bIn)
{
if (pParams[nIndex].bOut) // inout
{
uno_destructData( pUnoArgs[nIndex], pparamTypeDescr, 0
    ); // destroy uno value
uno_copyAndConvertData ( pUnoArgs [nIndex],
    pCppArgs [nIndex], pParamTypeDescr, &pThis-
    >pBridge−>aCpp2Uno );
}
}
else // pure out
{
uno_copyAndConvertData ( pUnoArgs [nIndex],
    pCppArgs [nIndex], pParamTypeDescr, &pThis-
    >pBridge−>aCpp2Uno );
}
// destroy temp cpp param => cpp: every param was
// constructed
uno_destructData ( pCppArgs [nIndex], pParamTypeDescr,
    cpp release );
TYPELIB_DANGER_RELEASE ( pParamTypeDescr );
}
// return value
if (pCppReturn && pUnoReturn != pCppReturn)
{
uno_copyAndConvertData( pUnoReturn, pCppReturn,
    pReturnTypeDesCr,
&pThis−>pBridge−>aCPP2Uno );
uno_destructData( pCppReturn, pReturnTypeDescr,
    cpp_release
}
}
_except (msci_filterCppException(
    GetExceptionInformation(), *ppunoExc, &pThis-
    >pBridge−>aCpp2Uno ))
{
// *ppUnoExc is untouched and any was constructed by
// filter function _finally block will be called
return;
}
}
_finally
{
// cleanup of params was already done in reconversion
// loop if no exception occured; this is quicker than
// getting all param descriptions twice! so cleanup
// only if an exception occured:
if (*ppUnoExc)
{
// temporary params
while (nTempIndizes--)
{
sal_Int32 nIndex = pTempIndizes [nTempIndizes];
// destroy temp cpp param => cpp: every param was
// constructed
uno_destructData ( pCppArgs [nIndex],
    ppTempParamTypeDescr[nTempIndizes], cpp_release );
TYPELIB_DANGER_RELEASE(
    ppTempParamTypeDescr[nTempIndizes] );
}
}
// return type
if (pReturnTypeDescr)
TYPELIB_DANGER_RELEASE ( pReturnTypeDescr );
}
}
```

In FIG. 12, read parameters operation 1201 reads the parameters from the call. Read parameters operation 1201 transfers to convert parameters operation 1202. Convert parameters operation 1202 converts the parameters read to the C++ environment. A C++ call stack is built in memory. All simple types, up to eight bytes are put directly on the stack, and all other types are referenced by a pointer. Operation 1202 transfers to allocate memory operation 1203. Allocate memory operation 1203 allocates memory for the out parameters returned by the call to the C++ interface, and for the return value. Allocate memory operation 1203 transfers processing to dispatch call operation 1204.

Dispatch call operation 1204 performs a C++ virtual call on the C++ interface. In one embodiment, method callVirtual, an assembly function performing the specific virtual call having the right registers set (See Table 18), is called and passed an array that is the call stack. The call is executed in the C++ environment and the results, if any, are returned to operation 1204 that in turn transfers to exception check operation 1205.

Exception check operation 1205 determines whether an exception was thrown in response to the call. If an exception was thrown, check operation 1205 transfers processing to convert exception operation 1210 and otherwise processing transfers to set exception operation 1220.

Convert exception operation 1210 converts the C++ exception to the UNO environment, and sets an exception out any with the converted exception. Operation 1210 transfers to clean up operation 1211 that in turn cleans up any temporary parameters that were created in the call in operation 1204 and transfers to return to operation 1130.

If an exception was not thrown in the source environment, set exception operation 1220 sets the exception out any to zero, and transfers to convert parameters operation 1221.

Convert parameters operation 1221 converts any parameters that were returned from operation 1204, e.g., out parameters and/or inout parameters, from the source environment, i.e., the C++ environment, to the destination environment, i.e., the UNO environment. Operation 1221 also cleans up any temporary parameters that were created in the call in operation 1204 and transfers to convert return value operation 1222. Operation 1222 converts any return value from the source environment to the destination environment so that both the return value and any returned parameters are written back, in this example to the UNO caller.

TABLE 18
AN EXAMPLE OF A METHOD
callVirtualMethod THAT IS USED BY THE UNO PROXY TO
DISPATCH A CALL TO THE INTERFACE IN THE C++
ENVIRONMENT

inline static void callVirtualMethod( void * pThis,
sal_Int32 nVtablelndex, void * pRegisterReturn,
typelib_TypeClass eReturnTypeClass, sal_Int32 *
pStackLongs, sal_Int32 nStackLongs )
{
// parameter list is mixed list of * and values
// reference parameters are pointers
OSL_ENSHURE( pStackLongs && pThis, “### null ptr!” );
OSL_ENSHURE( (sizeof(void *) == 4) &&
(sizeof(sal_Int32) == 4), “### unexpected size of int!”
);
___asm
{

| | |
|---|---|
| mov | eax, nStackLongs |
| test | eax, eax |
| je | Lcall |

// copy values

| | |
|---|---|
| mov | ecx, eax |
| shl | eax, 2 // sizeof(sal_Int32) == 4 |
| add | eax, pStackLongs // params stack space |

| | | |
|---|---|---|
| Lcopy: | sub | eax, 4 |

| | |
|---|---|
| push | dword ptr [eax] |
| dec | ecx |
| jne | Lcopy |

Lcall:
// call

| | |
|---|---|
| mov | ecx, pThis |
| push | ecx // this ptr |
| mov | edx, [ecx] // pvft |
| mov | eax, nVtableIndex |
| shl | eax, 2 // sizeof(void *) == 4 |
| add | edx, eax |

call [edx]//interface method call must be __cdecl!

// register return

| | |
|---|---|
| mov | ecx, eReturnTypeClass |
| cmp | ecx, typelib_TypeClass_VOID |
| je | Lcleanup |
| mov | ebx, pRegisterReturn |

// int32

| | |
|---|---|
| cmp | ecx, typelib_TypeClass_LONG |
| je | Lint32 |
| cmp | ecx, typelib_TypeClass_UNSIGNED_LONG |
| je | Lint32 |
| cmp | ecx, typelib_TypeClass_ENUM |
| je | Lint32 |

// int8

| | |
|---|---|
| cmp | ecx, typelib_TypeClass_BOOLEAN |
| je | Lint8 |
| cmp | ecx, typelib_TypeClass_BYTE |
| je | Lint8 |

// int16

| | |
|---|---|
| cmp | ecx, typelib_TypeClass_CHAR |
| je | Lint16 |
| cmp | ecx, typelib_TypeClass_SHORT |
| je | Lint16 |
| cmp | ecx, typelib_TypeClass_UNSIGNED_SHORT |
| je | Lint16 |

// float

| | |
|---|---|
| cmp | ecx, typelib_TypeClass_FLOAT |
| je | Lfloat |

// double

| | |
|---|---|
| cmp | ecx, typelib_TypeClass_DOUBLE |
| je | Ldouble |

// int64

| | |
|---|---|
| cmp | ecx, typelib_TypeClass_HYPER |
| je | Lint64 |
| cmp | ecx, typelib_TypeClass_UNSIGNED_HYPER |
| je | Lint64 |
| jmp | Lcleanup // no simple type |

Lint8:

| | |
|---|---|
| mov | byte ptr [ebx], al |
| jmp | Lcleanup |

Lint 16:

| | |
|---|---|
| mov | word ptr [ebx], ax |
| jmp | Lcleanup |

Lfloat:

| | |
|---|---|
| fstp | dword ptr [ebx] |
| jmp | Lcleanup |

Ldouble:

| | |
|---|---|
| fstp | qword ptr [ebx] |
| jmp | Lcleanup |

Lint64:

| | |
|---|---|
| mov | dword ptr [ebx], eax |
| mov | dword ptr [ebx+4], edx |
| jmp | Lcleanup |

Lint32:

| | |
|---|---|
| mov | dword ptr [ebx], eax |
| jmp | Lcleanup |

Lcleanup:
// cleanup stack (obsolete though because of function)

| | |
|---|---|
| mov | eax, nStackLongs |
| shl | eax, 2// sizeof(sal_Int32) == 4 |
| add | eax, 4 // this ptr |
| add | esp, eax |
| } | |

}

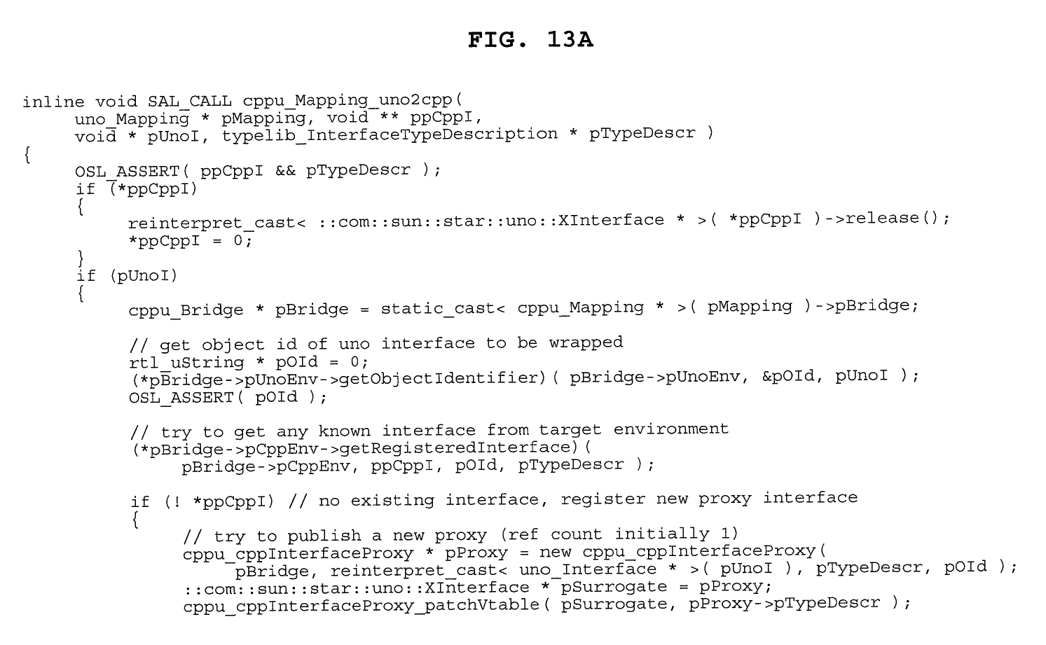

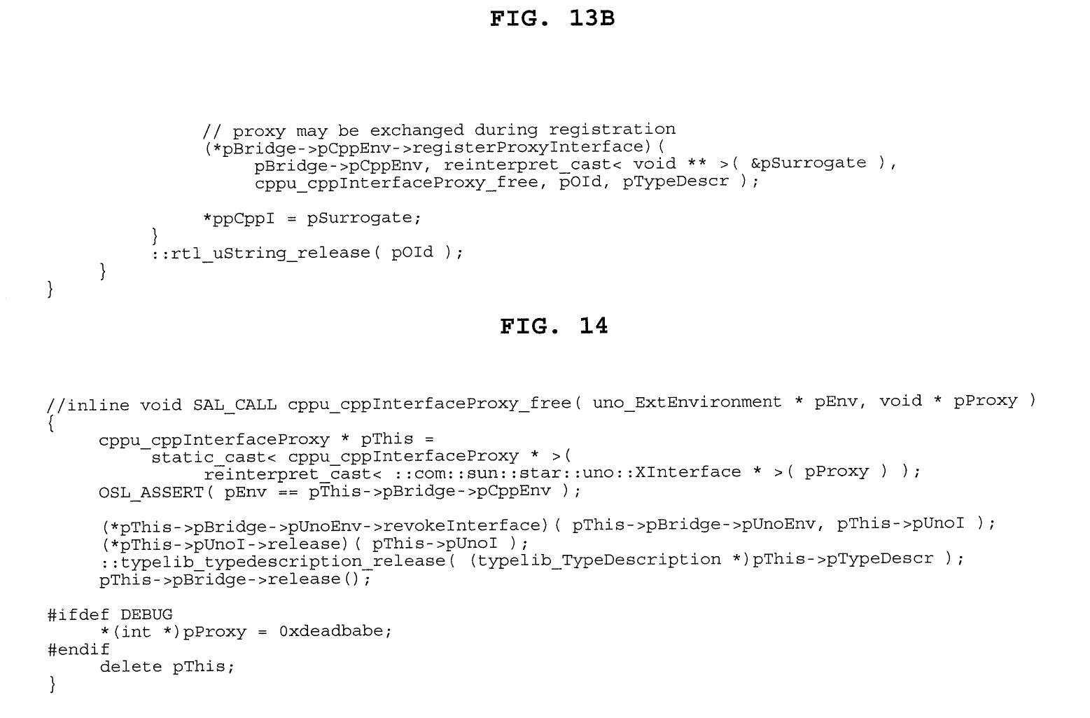

In the above description of the example, various methods were described and discussed. FIGS. 13A to 24 are specific examples of one embodiment of such methods. In particular, in FIGS. 13A and 13B, an embodiment of mapping an interface from the UNO environment to the C++ environment is presented. See FIG. 4.

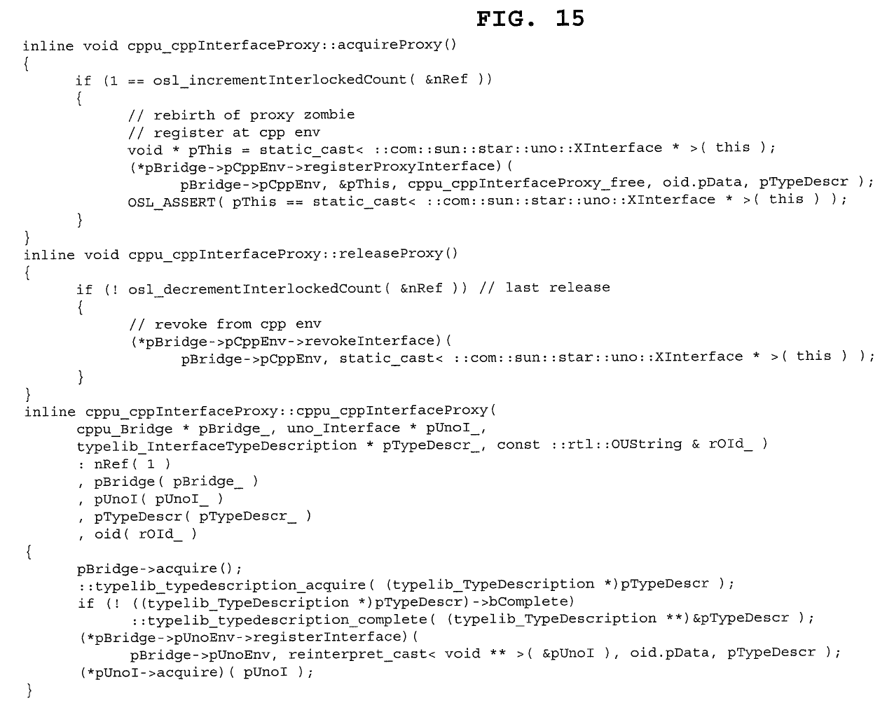

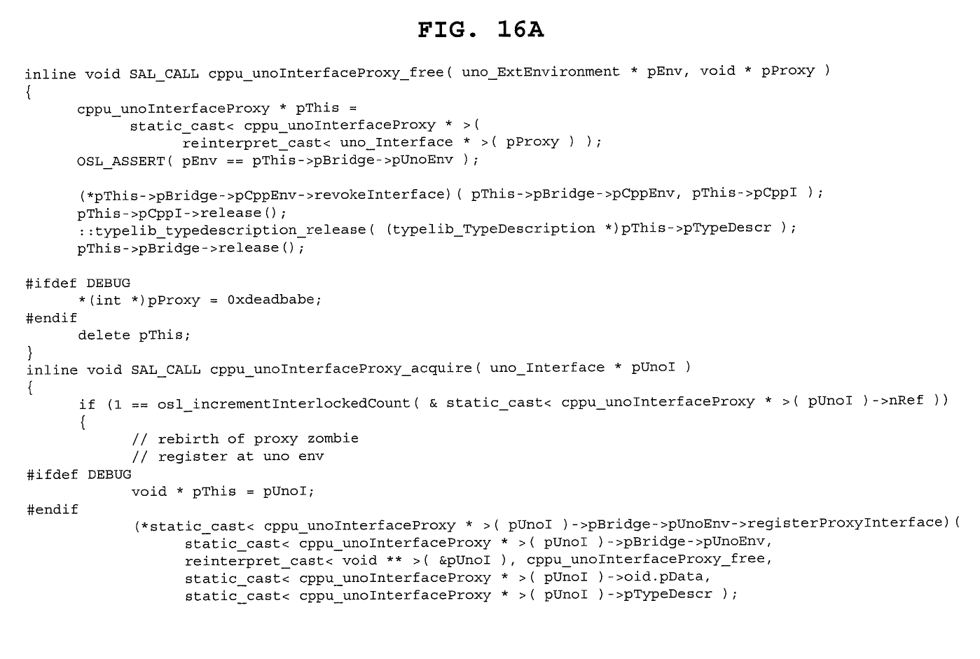

FIG. 14 is an example of a method free and a method for revoking the proxy. Method free is called indirectly by the C++ proxy described above when the reference count goes to zero and the C++ proxy should be deleted. FIG. 15 includes an example of a C++ proxy that includes a method acquireProxy; an example of a method releaseProxy that is used to revoke the C++ proxy from the C++ environment structure; and a method ccpu_cppInterfaceProxy to instantiate, acquire and register the C++ proxy.

FIGS. 16A and 16B include an example of a method free that is called indirectly by the UNO proxy described above when the reference count goes to zero and the UNO proxy should be deleted; an example of a method acquire that is used in acquiring the UNO proxy; and an example of a method release that is used to revoke the UNO proxy.

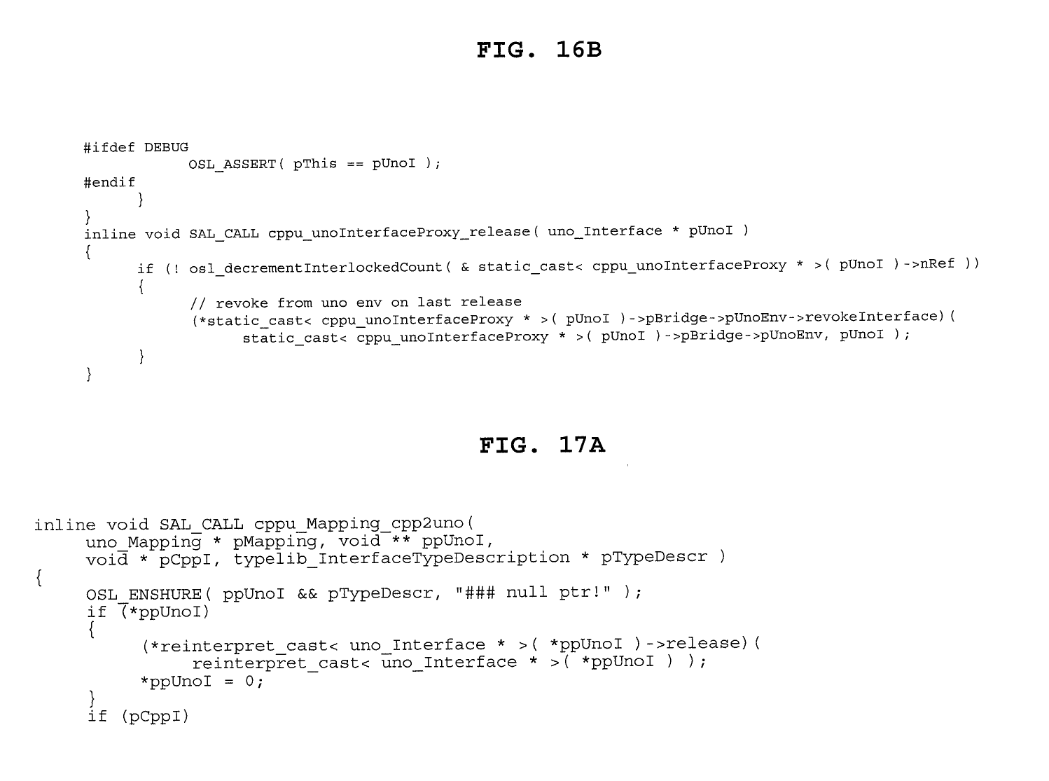

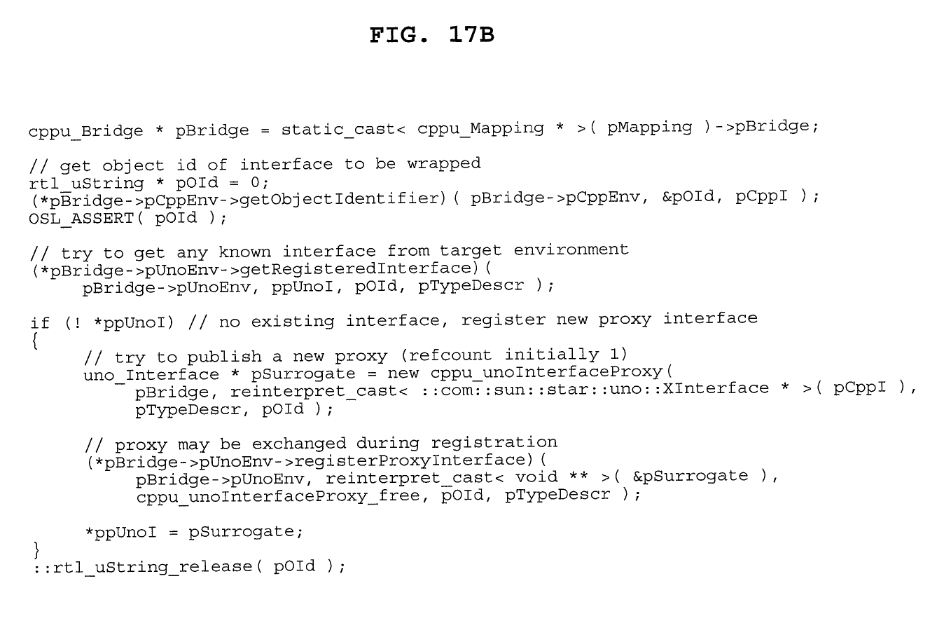

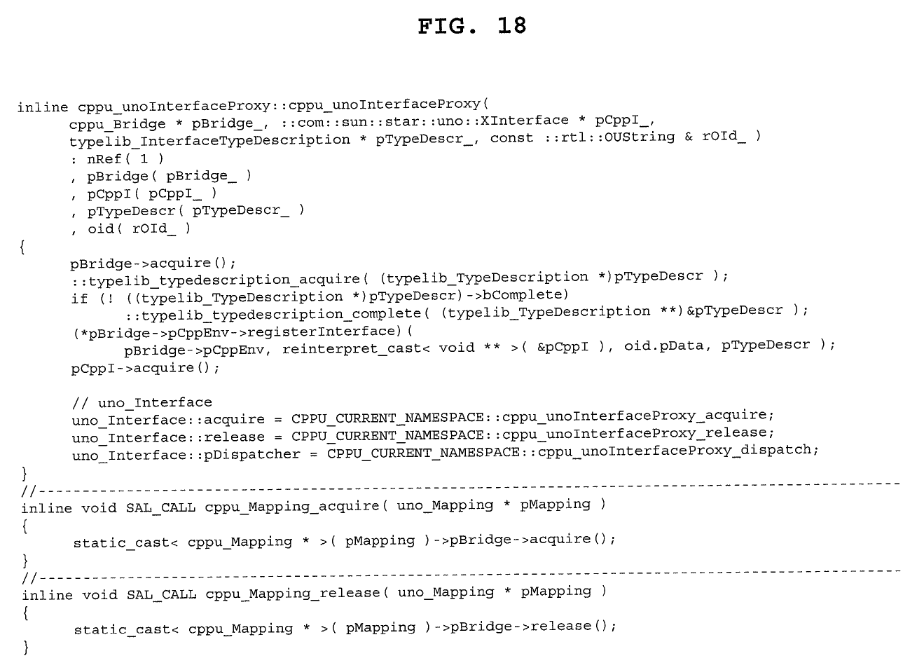

In FIGS. 17A and 17B, an embodiment of a method Mapping for mapping from the C++ environment to the UNO environment is presented. FIG. 18 includes is a C++ implementation of the UNO proxy that includes a constructor cpu_unoInterfaceProxy to instantiate, acquire and register the UNO proxy; a method for acquiring a mapping and a method for releasing a mapping.

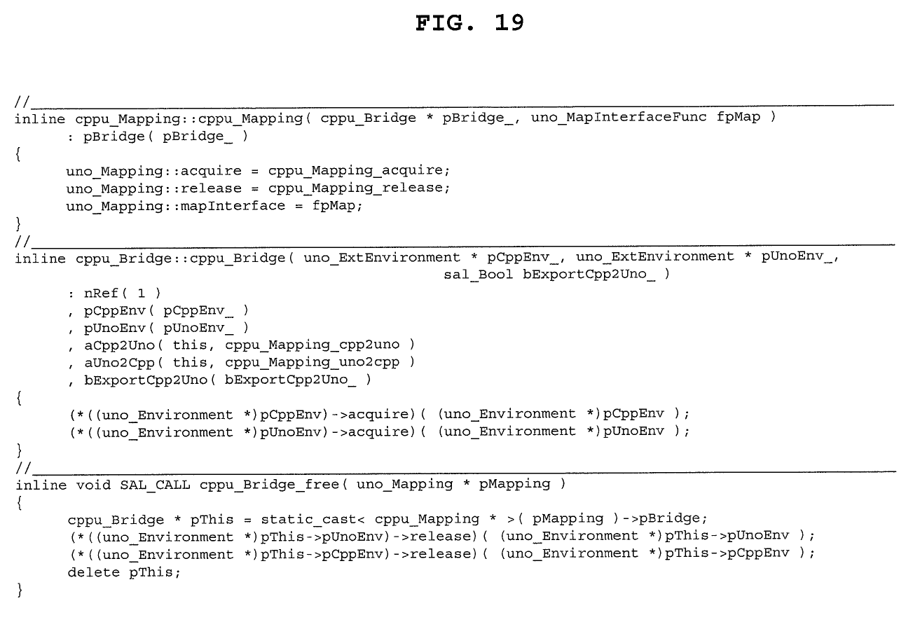

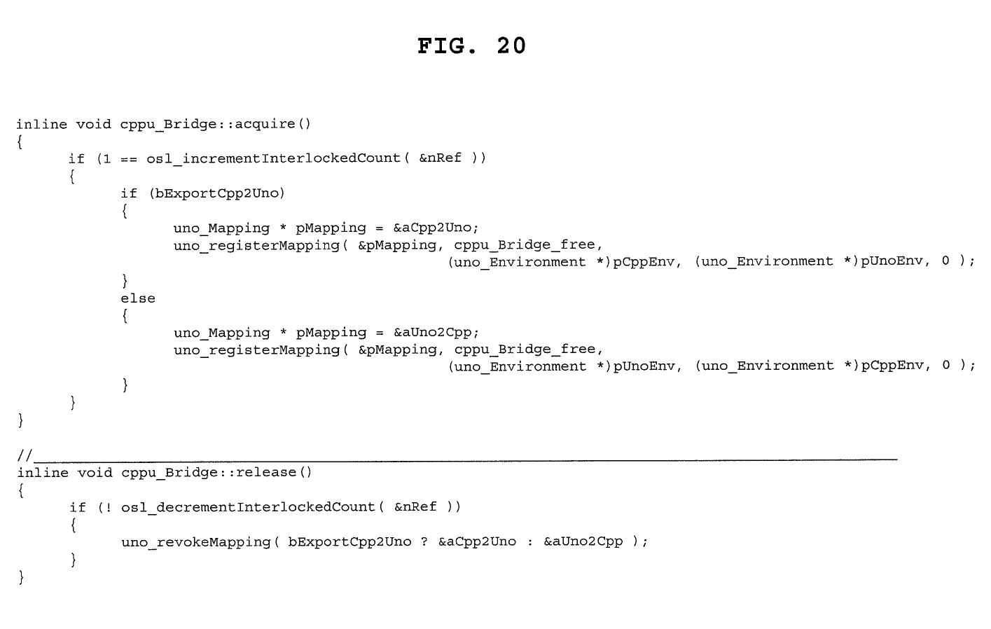

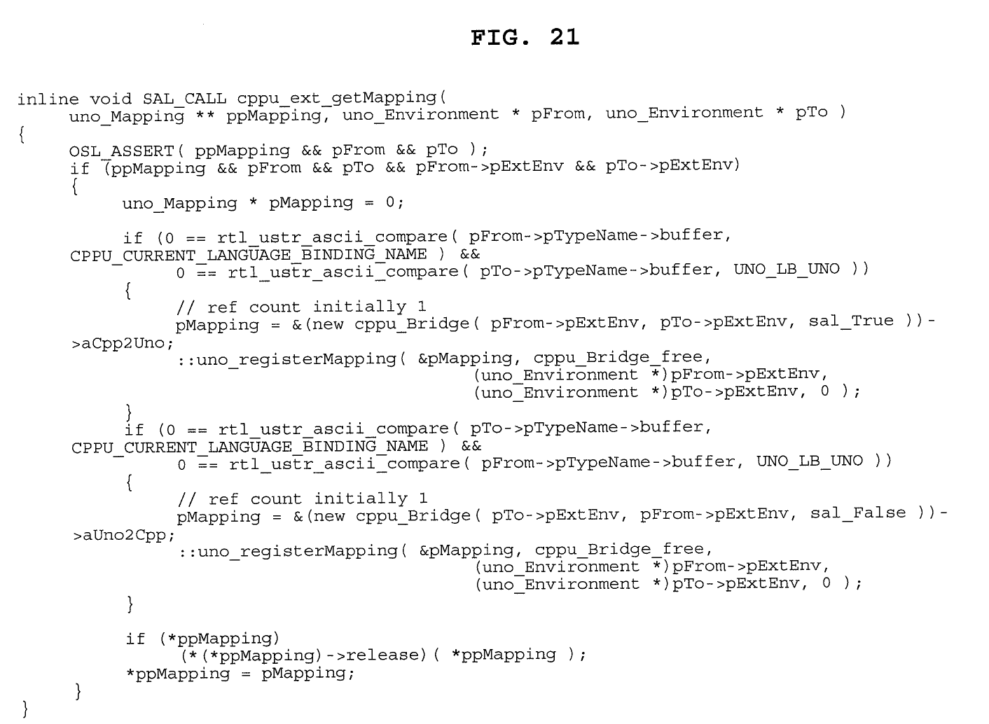

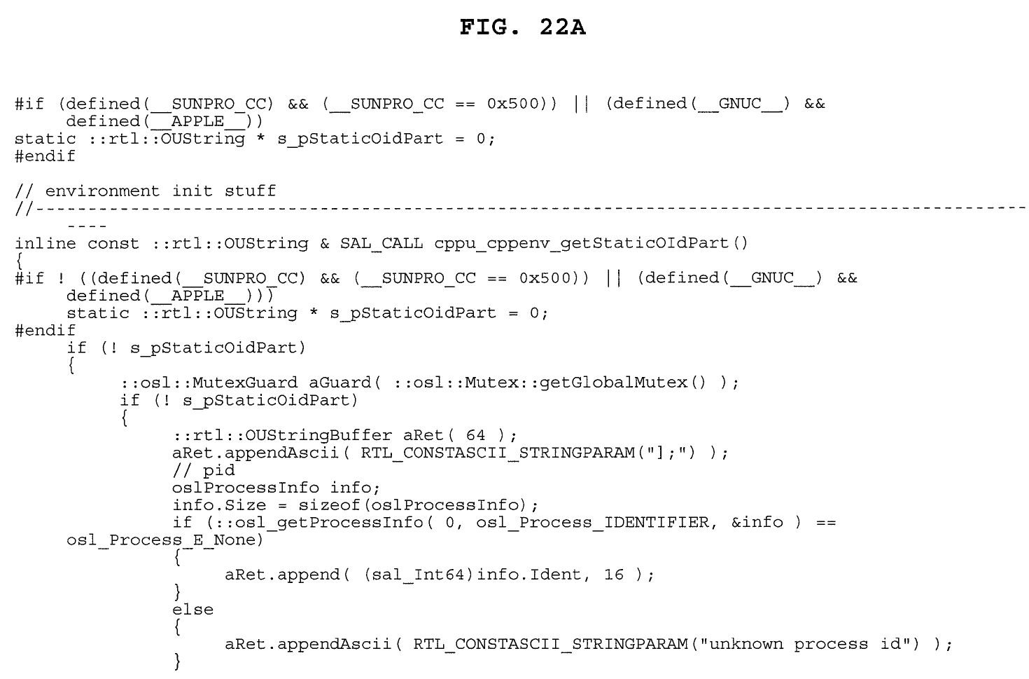

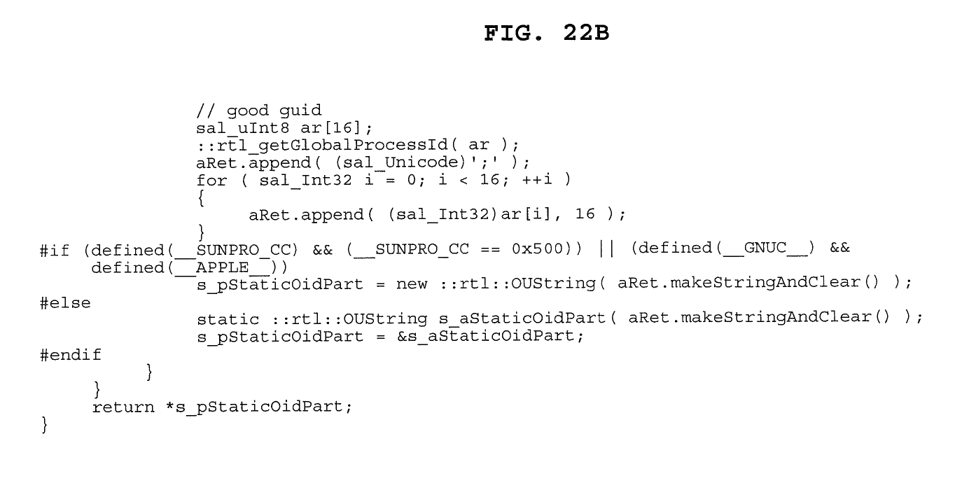

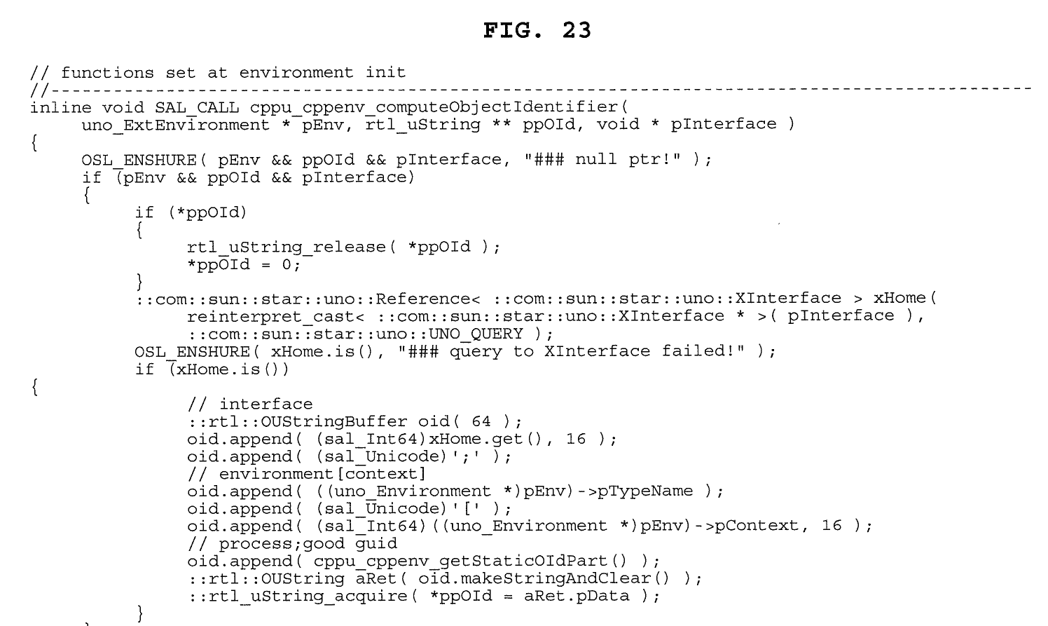

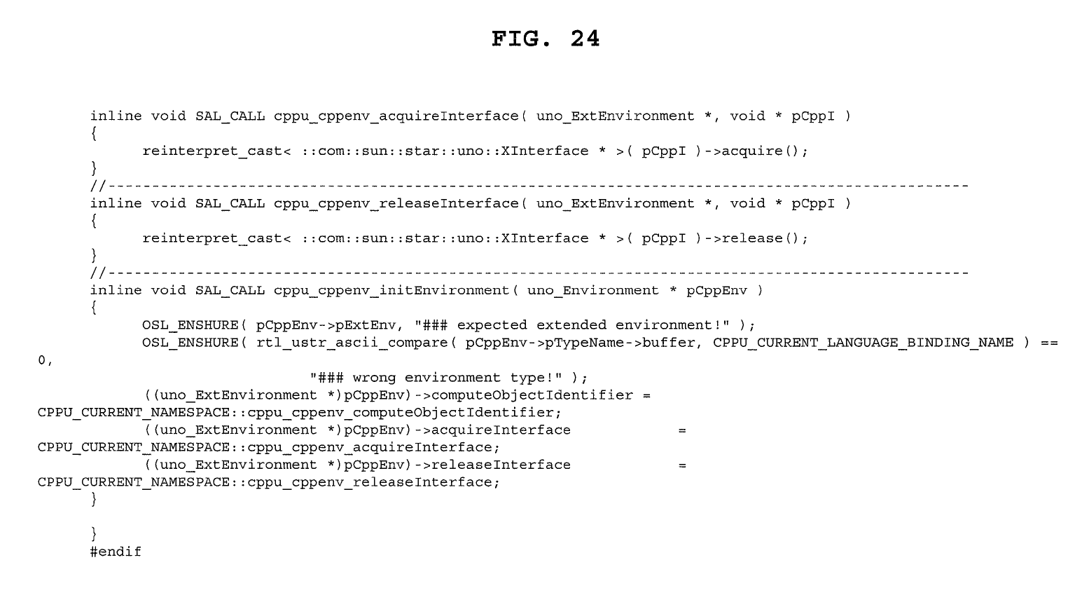

FIG. 19 illustrates constructors for a mapping and a bridge; and a method for freeing a bridge. FIG. 20 is an embodiment of methods for acquiring and releasing a bridge. FIG. 21 includes a method cppu_ext_getMapping to create a mapping between two specified environments. FIG. 22 is an embodiment of a method to create the static part of an object Id. The object id contains two parts, an object specific part and a static part. FIG. 23 is an embodiment of a method to create a complete object Id, containing both, the object specific and the static parts. FIG. 24 includes a method for acquiring a C++-uno environment; a method for releasing a C++-uno environment; and a method to initialize a C++-uno environment.

I claim:

1. A method for enabling a first software program using a first binary specification in a first execution environment to employ a limited functionality of a second software program using a second binary specification in a second execution environment, the method comprising:
creating a bridge in said first execution environment; and
creating, in said first execution environment using said bridge, a proxy wrapping an interface to said limited functionality of said second software program in said second execution environment.

2. A method as in claim 1 further comprising:
creating a first execution environment object including said second binary specification.

3. A method as in claim 2 further comprising:
creating a second execution environment object including said first binary specification.

4. A method comprising:
generating a binary specification object for a first execution environment;
generating a binary specification object for a second execution environment; and
generating a bridge object wherein said bridge object is used in mapping objects from said second execution environment to said first execution environment.

5. The method of claim 4 further comprising:
using said bridge object to generate a proxy wrapping an interface in said second execution environment.

6. A method for using functionality in a second execution environment in a first execution environment comprising:
calling a method in a proxy interface in said first execution environment; and
converting said method call by said proxy interface to a corresponding method call for execution in said second execution environment.

7. The method as in claim 6 further comprising:
dispatching said corresponding method call for execution in said second execution environment to said second execution environment by said proxy interface.

8. The method of claim 6 where said converting said method call further comprises:
using a type description to convert parameters from said first execution environment to said second execution environment.

9. The method of claim 7 further comprising:
executing said corresponding method call in said second execution environment, and returning results of said execution to said proxy interface.

10. The method of claim 9 further comprising:
using a type description to convert said returned results from said second execution environment to said first execution environment.

11. The method of claim 6 wherein said second execution environment is a C++ programming language execution environment.

12. A method for using functionality in a second execution environment in a first execution environment comprising:
calling a method in a proxy interface in said first execution environment;
converting said method call by said proxy interface to a corresponding method call for execution in said second execution environment, wherein said converting said method call comprises:
using a type description to convert parameters from said first execution environment to said second execution environment; and
dispatching said corresponding method call for execution in said second execution environment to said second execution environment by said proxy interface.

13. The method of claim 12 further comprising:
executing said corresponding method call in said second execution environment, and returning results of said execution to said proxy interface.

14. The method of claim 13 further comprising:
using a type description to convert said returned results from said second execution environment to said first execution environment.

15. A computer program product comprising computer program code for a method for enabling a first software program using a first binary specification in a first execution environment to employ a limited functionality of a second software program using a second binary specification in a second execution environment, the method comprising:
creating a bridge in said first execution environment; and
creating, in said first execution environment using said bridge, a proxy wrapping an interface to said limited functionality of said second software program in said second execution environment.

16. The computer program product of claim 15 wherein said method further comprises:
creating a first execution environment object including said second binary specification.

17. The computer program product of claim 16 wherein said method further comprises:
creating a second execution environment object including said first binary specification.

18. A computer program product comprising computer program code for a method for using functionality in a second execution environment in a first execution environment, said method comprising:
calling a method in a proxy interface in said first execution environment; and
converting said method call by said proxy interface to a corresponding method call for execution in said second execution environment.

19. The computer program product of claim 18 wherein said method further comprises:
dispatching said corresponding method call for execution in said second execution environment to said second execution environment by said proxy interface.

20. The computer program product of claim 18 wherein said method further comprises:
using a type description to convert parameters from said first execution environment to said second execution environment.

21. The computer program product of claim 19 wherein said method further comprises:
executing said corresponding method call in said second execution environment, and returning results of said execution to said proxy interface.

22. The computer program product of claim 21 wherein said method further comprises:
using a type description to convert said returned results from said second execution environment to said first execution environment.

23. A computer storage medium having stored therein a structure comprising:
a binary specification for an execution environment including:
a simple common identity structure.

24. The computer storage medium of claim 23 wherein said binary specification further comprises:
an extended environment structure.

25. The computer storage medium of claim 23 wherein said simple common identity structure includes:
a type name.

26. The computer storage medium of claim 23 wherein said simple common identity structure includes:
a method acquire.

27. The computer storage medium of claim 23 wherein said simple common identity structure includes:
a method release.

28. The computer storage medium of claim 24 wherein said simple common identity structure includes:
a pointer to said extended environment structure.
